(19) United States
(12) Patent Application Publication
(10) Pub. No.: US 2026/0236431 A1
(43) Pub. Date: Aug. 13, 2026

(54) THREE-DIMENSIONAL ARTIFICIAL INTELLIGENCE PROCESSOR BASED ON FINE-GRAINED CUBE ARCHITECTURE AND METHOD FOR DESIGNING THE SAME

(71) Applicant: CITY UNIVERSITY OF HONG KONG, Kowloon (HK)

(72) Inventors: Yulong CHEN, Kowloon (HK); Yingxia LIU, Kowloon (HK)

(73) Assignee: CITY UNIVERSITY OF HONG KONG, Kowloon (HK)

(21) Appl. No.: 19/452,839

(22) Filed: Jan. 19, 2026

Related U.S. Application Data
(60) Provisional application No. 63/757,697, filed on Feb. 12, 2025.

(51) Int. Cl. G06F 15/80

(52) U.S. Cl. CPC G06F 15/803; G06F 15/8023

(57) ABSTRACT

A 3D AI processor based on a Fine-Grained Cube (FGC) architecture and a method for designing the same are provided. The 3D AI processor includes an FGC array, a central scheduling module, a data management module, and a 3D power supply circuit. The FGC array includes a plurality of FGC modules arranged in an expandable three-dimensional layout. Each FGC module includes one or more computing units, one or more memory units, and one or more logic units that are integrated through a Memory Fusion Computing architecture. Data transmission between the FGC modules and between the FGC modules and the central scheduling module is performed via a data interaction protocol. The central scheduling module is configured to configure corresponding functions for the FGC modules according to the data interaction protocol, configure data attributes, authorize a selected count of FGC modules, and monitor a portion of the authorized FGC modules.

### CROSS REFERENCES TO RELATED APPLICATIONS

This application claims priority to U.S. Provisional Patent Application No. 63/757,697, filed on Feb. 12, 2025, the entire contents of which are hereby incorporated by reference.

### TECHNICAL FIELD

The present disclosure relates to the field of integrated circuits, and in particular, to a three-dimensional (3D) artificial intelligence (AI) processor based on a Fine-Grained Cube (FGC) architecture and a method for designing the same.

### BACKGROUND

With the increasing demands for chip performance and functionality in the industry, the count of transistors in modern chips has reached hundreds of millions, interconnects have become denser, and the integration level of functional modules continues to improve. Currently, the industry commonly adopts the manner of scaling down transistor sizes to enhance chip performance. However, as transistor sizes approach 2 nm, further scaling leads to issues such as reduced yield, increased cost, and decreased reliability. Furthermore, smaller sizes imply higher power density, which exacerbates thermal management challenges. Based on this, adopting advanced 3D packaging technology has become one of the effective solutions for balancing chip cost and performance. 3D packaging technology is an advanced integrated circuit packaging technique that vertically stacks multiple chips to achieve higher integration density and performance. Through-Silicon Via (TSV) and flip-chip bonding technologies are key technologies for realizing 3D Integrated Circuits (3D ICs) in 3D packaging technology.

3D packaging technology primarily focuses on chip-level packaging, involving research centered around different process technologies and manufacturing raw materials. The key research areas include the following three aspects:
Chip stacking and reliability: How to achieve reliable stacking between chips and maintain good electrical performance, involving techniques such as copper-copper bonding, hybrid bonding, solder technologies, and TSV technologies using different substrates (e.g., silicon-based substrates, glass-based substrates). Simultaneously, 3D packaging technology must also consider the compatibility and reliability between packaging materials (e.g., low-k dielectric materials, passivation layers, adhesion layers, etc.) and TSVs, solder balls.
High-speed communication: How to achieve high-speed communication between chips on the same layer, including physical layer high-speed channel design and research on communication protocols for chip interaction, utilizing technologies such as Embedded Multi-die Interconnect Bridge (EMIB), Extremely Large Area Integrated Circuit (ELAIC), and Redistribution Layer (RDL). The goal of high-speed communication is to reduce latency and increase bandwidth to meet the data exchange requirements between heterogeneous chips.
Chip layout and thermal management: How to rationally arrange chip layouts to shorten the distance between memory chips and logic chips, effectively reducing interconnect delay and power consumption. Concurrently, in response to potential heat dissipation bottlenecks caused by 3D stacking, it is necessary to optimize the packaging structure and thermal paths to improve the performance and stability of the entire system.

Based on the aforementioned research, 3D packaging technology has been successfully applied in the field of memory chips, such as 3D NAND FLASH and 3D High Bandwidth Memory (HBM) (as shown in FIG. 1).

However, due to thermal issues and architectural limitations, the application of 3D packaging technology in the field of logic chips still faces challenges.

The thermal issues refer to the fact that the transistor density and interconnect density of memory chips are far lower than those of computing chips, resulting in higher and more concentrated heat generation in computing chips. The 3D stacked structure itself makes it difficult to dissipate heat quickly, thereby making it challenging to ensure chip reliability.

The architectural limitations refers to problems inherent in the von Neumann architecture, which is currently predominantly used in computing chips. The von Neumann architecture features a separated design of computation (CPU) and memory, with data interaction occurring via bus protocols. As computational complexity and the count of modules increase, the high-density interconnection paths between the CPU and memory consume significant power and substantially increase communication latency.

Currently, using Chiplet technology and advanced 3D packaging technology does help reduce communication latency. However, localized hotspot issues remain difficult to resolve, and the overall reliability of the chip still cannot be fully guaranteed. Under existing process conditions, relying solely on 3D packaging technology makes it difficult to achieve mass production of three-dimensional stacked logic chips.

Therefore, there is a need to provide a three-dimensional artificial intelligence processor based on a Fine-Grained Cube (FGC) architecture and a method for designing the same. Based on a three-dimensional integrated circuit structure, the processor integrates front-end logic design with back-end layout concepts based on advanced packaging technology. This can significantly enhance the processor's processing speed in parallel computing while substantially reducing the chip's power consumption, thereby mitigating the thermal issues present in the existing technologies. The processor adopts a Memory Fusion Computing architecture, capable of completing the training and inference of artificial intelligence models without relying on traditional instruction execution architectures (such as CPUs or FPGAs) or external memory devices (such as Dynamic Random-Access Memory (DRAM) or HBM), effectively overcoming the von Neumann architecture and the “memory wall bottleneck” associated with it.

### SUMMARY

One or more embodiments of the present disclosure provide a three-dimensional (3D) artificial intelligence (AI) processor based on a Fine-Grained Cube (FGC) architecture, comprising: an FGC array, a central scheduling module, a data management module, and a 3D power supply circuit. The FGC array includes a plurality of FGC modules arranged in an expandable three-dimensional layout; each of the plurality of FGC modules includes one or more computing units, one or more memory units, and one or more logic units that are integrated through a Memory Fusion Computing architecture; the one or more computing units are configured to perform data operations, the one or more memory units are configured to store data, and the one or more logic units are configured to determine a type of operation to be performed on data; each of the FGC modules further comprises one or more cache modules configured to cache data. Data transmission between the plurality of FGC modules and between the plurality of FGC modules and the central scheduling module is performed via a data interaction protocol. The central scheduling module is configured to perform corresponding functional configuration of the FGC modules based on the data interaction protocol, configure data attributes, authorize a selected count of FGC modules according to a hierarchical management mechanism, and monitor a portion of the authorized FGC modules. The data management module is configured for data communication with an external device. The 3D power supply circuit is configured for system power supply.

One or more embodiments of the present disclosure provide a method for designing a three-dimensional (3D) artificial intelligence (AI) processor based on a Fine-Grained Cube (FGC) architecture, the method being applied to the 3D AI processor based on the FGC architecture. The method comprises:
S1. FGC architecture design: wherein the FGC architecture design comprises an FGC array design, including designing a topology structure for a 3D stacked distribution of the plurality of FGC modules according to different application requirements and applicable scenarios.
S2. FGC module design: wherein each of the plurality of FGC modules has a 3D stacked structure, and the FGC module design comprises designing the 3D stacked structure of the one or more computing units, the one or more memory units, and the one or more logic units of each of the plurality of FGC modules, such that the one or more computing units, the one or more memory units, and the one or more logic units are closely laid out based on the Memory Fusion Computing architecture, and a distribution of each functional unit is selected as a single-layer distribution or a distribution across multiple chip layers based on application requirements.
S3. Data interaction protocol design: wherein the data interaction protocol designed comprises: adding data attributes to input data to the plurality of FGC modules and modifying data attributes of output data from the plurality of FGC modules, to achieve scheduling control of data flow paths, wherein the plurality of FGC modules execute corresponding operations on the data based on the data attributes; and performing authorized management of the plurality of FGC modules according to a hierarchical management mechanism, wherein the central scheduling module grants group leader authority to a selected count of FGC modules, and the FGC modules granted the group leader authority monitor data flow states of FGC modules in adjacent regions to prevent excessive divergence of data flow.
S4. Three-dimensional (3D) stacked chip packaging design: wherein the 3D stacked chip packaging design comprises packaging a plurality of chip layers using a 3D packaging technology, wherein high-density through-silicon vias (TSVs) are used as inter-layer interconnect structures for physical connections.
S5. Low-power and reliability design: wherein the low-power and reliability design comprises: designing the 3D power supply circuit, and performing low-power optimization by powering down idle FGC modules or powering on standby FGC modules in the FGC array; and designing redundant circuits in the plurality of FGC modules, such that when a portion of the plurality of FGC modules or a functional unit within an FGC module fail, an automatic switch is made to other FGC modules or other functional units to complete substitute tasks.
S6. Optimization combining a front-end logic design and a back-end packaging structure design: wherein the front-end logic design includes adopting a circuit layout from step S2 and a data flow path algorithm from step S3 that are adapted to three-dimensional stacking requirements, such that the FGC array is designed with the plurality of chip layers, and circuit design takes into account communication latency between the plurality of chip layers; and the back-end packaging structure design includes optimizing a physical structure of a 3D circuit based on a count of interconnects in the plurality of FGC modules from the front-end design, so as to ensure that requirements for high-density TSV manufacturing are met.
S7. Other modules and packaging interface design, comprising: designing the data management module, the central scheduling module, a chip input/output (I/O), and an external package for the plurality of chip layers of each of the plurality of FGC modules.

In one or more embodiments of the present disclosure, a three-dimensional (3D) artificial intelligence (AI) processor based on Fine-Grained Cube (FGC) architecture and a corresponding design method are provided. The processor adopts a three-dimensional integrated circuit structure that combines a front-end logic architecture with a back-end layout design enabled by advanced packaging technologies. This co-optimization significantly enhances processing speed in parallel-computing scenarios while substantially reducing chip power consumption, thereby alleviating thermal issues commonly encountered in three-dimensionally stacked chips.

The embodiments of the present disclosure utilize a Memory Fusion Computing architecture, in which computing units, memory units, and logic units are tightly integrated into multiple FGC modules. This architecture eliminates the reliance inherent in conventional CPU/GPU systems on a “centralized-compute-centralized-memory” model that requires frequent access to external memory (e.g., DRAM or HBM). As a result, data-movement overhead is fundamentally reduced, overcoming the “memory wall” bottleneck associated with the von Neumann architecture. In addition, the distributed nature of the FGC modules effectively mitigates localized hotspot issues and thermal-management challenges caused by 3D stacking technologies.

The embodiments of the present disclosure employ advanced three-dimensional integrated circuit packaging technologies (such as Through-Silicon Vias (TSVs), hybrid bonding, and low-temperature flip-chip bonding) to provide high-density vertical interconnection structures, thereby increasing signal-transmission bandwidth and improving chip stability.

The data interaction protocol between FGC modules in the embodiments of the present disclosure is based on a dataflow-driven computing model, avoiding the instruction overhead inherent in traditional instruction-controlled architectures. This decentralized management scheme enables computing tasks to be allocated and executed autonomously, achieving high-efficiency, low-latency data transfer and increasing system throughput.

The embodiments of the present disclosure utilize a modular FGC design that supports flexible scaling. In practical application scenarios, greater computational performance can be achieved by stacking more FGC modules, or lower power consumption requirements can be met by powering down a portion of the FGC modules. These modifications do not require redesigning the data paths within the FGC modules. Additionally, the FGC modules are compatible with Chiplet technology, adhering to universal Chiplet protocol interfaces, allowing them to be embedded into current processor architectures as standalone AI acceleration modules or high-speed parallel processing modules.

The embodiments of the present disclosure are adaptable to mature semiconductor Complementary Metal-Oxide-Semiconductor (CMOS) manufacturing processes. With appropriate adjustments, they can be compatible with novel devices or technologies, including but not limited to: Gallium Nitride (GaN) devices, Silicon Photonics devices, Carbon Nanotube (CNT) devices, and new thermal interface materials, thereby providing support for flexible upgrades and broader application scenarios.

### BRIEF DESCRIPTION OF THE DRAWINGS

The present disclosure will be further explained by way of exemplary embodiments, which are described in detail with reference to the accompanying drawings. These embodiments are non-limiting, and in these embodiments, the same reference numerals denote the same structures, wherein:

FIG. 1 is a schematic structural diagram of a High Bandwidth Memory (HBM) (used to illustrate the layout design of small chip modules in 3D packaging technology).

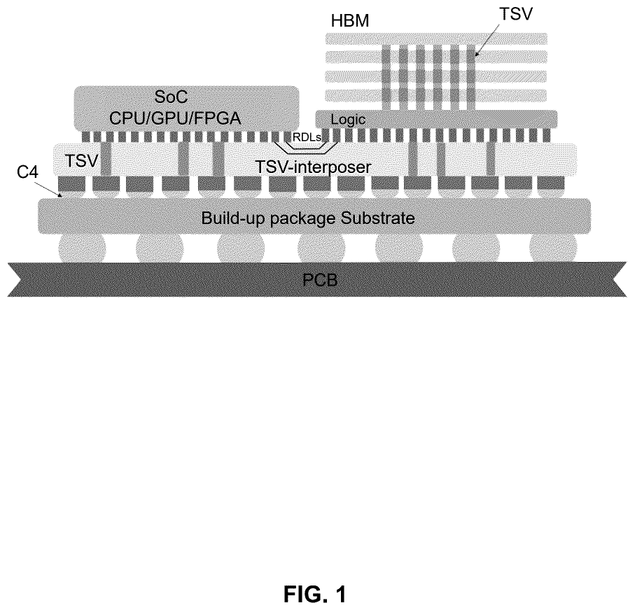

FIG. 2 is a schematic diagram of a chip architecture of a three-dimensional (3D) artificial intelligence (AI) processor based on a Fine-Grained Cube (FGC) architecture according to some embodiments of the present disclosure.

FIG. 3 is a schematic structural diagram of a Memory Fusion Computing architecture according to some embodiments of the present disclosure.

FIG. 4 is a schematic diagram illustrating different structural implementations of an FGC module according to some embodiments of the present disclosure.

FIG. 5 is a conceptual diagram of a 3D AI processor based on an FGC architecture according to some embodiments of the present disclosure.

FIG. 6 is a schematic front view of the structure of a 3D AI processor based on an FGC architecture according to some embodiments of the present disclosure.

FIG. 7 is a schematic top view of the structure of a 3D AI processor based on an FGC architecture according to some embodiments of the present disclosure.

FIG. 8 is a schematic diagram of data processing in an FGC module according to some embodiments of the present disclosure.

FIG. 9 is a schematic structural diagram of an FGC module according to some embodiments of the present disclosure.

FIG. 10 is a schematic diagram of a two-dimensional array of FGCs with coordinates x0z in an FGC chip according to some embodiments of the present disclosure.

FIG. 11 is a schematic diagram of two hierarchical management modes in an inter-FGC module data interaction protocol according to some embodiments of the present disclosure.

FIG. 12 is a schematic top view showing a distribution of FGC system modules according to some embodiments of the present disclosure.

FIG. 13 is a schematic diagram of a data flow for forward propagation in an FGC system according to some embodiments of the present disclosure.

FIG. 14 is a schematic diagram of a data flow for backpropagation in a final neural network layer of an FGC system according to some embodiments of the present disclosure.

FIG. 15 is a schematic diagram of a data flow for backpropagation in other neural network layers of an FGC system according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

The following are technical explanations for Hybrid Bonding, Embedded Multi-die Interconnect Bridge (EMIB), High Bandwidth Memory (HBM), Artificial Intelligence (AI) processors, and the von Neumann architecture:

Hybrid Bonding is an advanced semiconductor packaging technology widely used in 3D ICs and heterogeneous integration, aiming to achieve higher density and higher performance chip interconnections. By combining multiple bonding techniques, hybrid bonding overcomes the limitations of traditional packaging technologies, providing tighter connections, lower power consumption, and higher bandwidth.

EMIB is a high-density interconnect technology used for 3D ICs and heterogeneous integration. EMIB achieves electrical connections between different chips (or chip layers) through an embedded bridge structure. A key characteristic of EMIB is that by embedding micro interconnect bridges in a silicon substrate, it supports high-speed data transmission between chips while avoiding the technical challenges associated with Through-Silicon Vias (TSVs) in traditional 3D IC technologies.

HBM is an advanced memory technology designed to enhance a data transfer rate and a memory bandwidth of a computing system. HBM is widely used in fields such as High-Performance Computing (HPC), Graphics Processing Units (GPUs), Artificial Intelligence (AI) accelerators, and high-end servers, providing higher bandwidth and lower power consumption. HBM adopts a 3D stacked architecture, vertically stacking multiple memory chips and using TSV technology to achieve high-speed interconnects between the chips. Each stacked memory module consists of multiple memory layers (typically DRAM chips) connected via a wide bus to achieve higher data throughput. HBM connects to a processor (e.g., a CPU or a GPU) through a high-speed interface, ensuring efficient data transfer and combining large memory capacity with high-speed data exchange. Compared to traditional memory layouts, HBM achieves significant improvements in both performance and power efficiency.

An Artificial Intelligence (AI) processor is a specialized processor designed specifically to accelerate AI algorithm models. Unlike traditional Central Processing Units (CPUs) or Graphics Processing Units (GPUs), AI processors provide more efficient performance by optimizing the computational architecture, particularly in areas such as matrix operations, parallel computing, and large-scale data processing. The design goal of an AI processor is to optimize for the specific requirements of AI applications such as deep learning, machine learning, computer vision, and natural language processing, demonstrating higher processing speeds, better energy efficiency, and higher computational density.

The von Neumann Architecture is a classic computer system architecture composed of five fundamental components: an input device, an output device, a control unit, an arithmetic logic unit, and a memory unit. The core characteristic of the von Neumann architecture is the “stored-program” concept, where program instructions and data reside in the same memory, and the Central Processing Unit (CPU) fetches and executes operations on them via the control unit. Although the von Neumann architecture remains widely used in modern computers, a bus bottleneck in data transfer between the memory and the computing unit leads to a “memory wall” problem. The bandwidth limitation forces the processor to frequently wait for data transfers when handling large datasets or complex computations, significantly constraining overall system performance improvement. Furthermore, the frequent data movement consumes substantial power. The energy consumption issue, stemming from the bottleneck, is particularly pronounced in scenarios such as large-scale data centers, high-performance computing platforms, or artificial intelligence model training. Frequent read/write operations between the memory and computing unit, current losses on the bus, and energy consumption during system idle states further exacerbate the overall system power consumption. These issues limit the applicability of the von Neumann architecture in contexts requiring low-power computing and highly efficient energy management.

The three-dimensional (3D) artificial intelligence (AI) processor based on a Fine-Grained Cube (FGC) architecture and its design method proposed in the present disclosure provide FGC modules that support flexible scaling. Computational capability can be adjusted by stacking FGC modules, and the design is compatible with Chiplet technology. The processor can be applied in fields requiring high-performance, large-scale parallel computing, such as artificial intelligence (AI) and deep learning. Exemplary application scenarios include: Large-scale AI model computation, autonomous driving and intelligent transportation, avionics, high-performance computing (HPC), smart manufacturing and industrial automation, and biomedical computing.

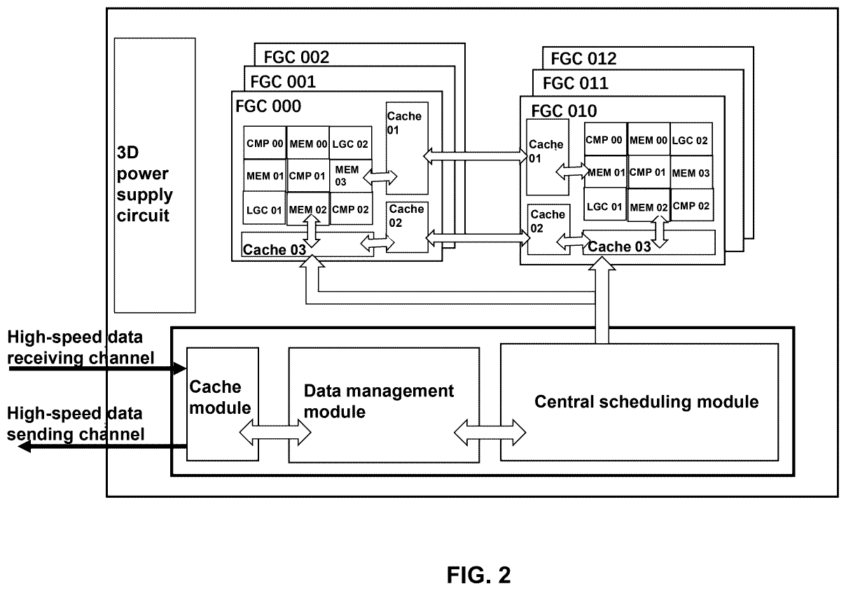

FIG. 2 is a schematic diagram of a chip architecture of a three-dimensional (3D) artificial intelligence (AI) processor based on a Fine-Grained Cube (FGC) architecture according to some embodiments of the present disclosure.

In some embodiments, as shown in FIG. 2, the three-dimensional artificial intelligence processor based on the Fine-Grained Cube architecture (also referred to as an FGC processor) comprises an FGC array, a central scheduling module, a data management module, and a three-dimensional (3D) power supply circuit.

The Fine-Grained Computing architecture (i.e., the FGC architecture, FGC Architecture) refers to an advanced computing architecture based on Fine-Grained Cube modules and a three-dimensional stacking structure. The FGC architecture within the FGC processor is designed for high-performance configurable parallel computing domains.

The three-dimensional stacked structure refers to an integrated circuit construction where multiple chip layers are physically stacked and electrically interconnected. The three-dimensional stacked structure achieves extremely high functional density within a minimal physical footprint and enhances data transfer speeds while reducing power consumption by shortening the physical distance between components.

The FGC array refers to a collection comprising multiple FGC modules, which collectively form a three-dimensional stacked structure. For example, the FGC array includes a plurality of scalable three-dimensional FGC modules arranged horizontally and/or vertically, thus forming an expandable three-dimensional layout. The expandable three-dimensional layout means that the FGC array may be adjusted by increasing or decreasing the count of FGC modules.

An FGC module refers to an integrated unit configured to implement primary functions of the FGC architecture. Each FGC module includes one or more computing units, one or more memory units, and one or more logic units.

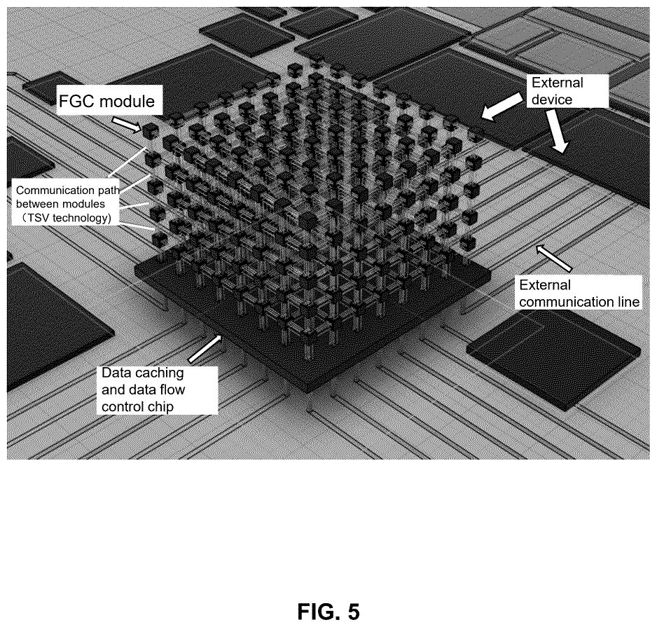

In some embodiments, as shown in FIG. 5, each FGC module is composed of a plurality of core units, including one or more computing units (CMP), one or more memory units (MEM), and one or more logic units (LGC). Within the FGC module, the computing unit(s), the memory unit(s), and the logic unit(s) may be integrated via a Memory Fusion Computing architecture and may be laid out on a single-layer 2D chip or a multi-layer 3D chip according to implementation requirements. For example, the core units of an FGC module may be integrated within a 2D chip on the same layer or stacked across multiple chip layers using 3D integration technology.

In some embodiments, the computing unit of the FGC module is configured to perform data operations, such as arithmetic operations, logical operations, or bitwise operations.

In some embodiments, the memory unit is configured to store data. Examples of the stored data include network model configuration parameters, input data, intermediate computation results, user data, or the like.

In some embodiments, the logic unit is configured to determine a type of operation to be performed on the data. For example, based on data attributes of the data, the logic unit determines the type of operation to be performed and directs the data flow to a corresponding functional unit.

In some embodiments, each FGC module further includes multiple sets of cache modules for buffering external data (including data from other FGC modules or input from the central scheduling module). These cache modules may have various compositions and employ multi-level architectures.

In some embodiments, the FGC module further includes a module power-gating logic unit. The module power-gating logic unit is configured to maintain the current FGC module in a powered-off state when there is no data input or stored data, thereby reducing system energy consumption.

The FGC processor features an integrated structure. The physical implementation of the integrated structure, i.e., the stacking arrangement of the FGC array, includes but is not limited to a cubic topology structure, a ring topology structure, a tree topology structure, a honeycomb topology structure, or the like, or any combination thereof. The stacking arrangement may be selected based on different application requirements. Different topological connection schemes enable flexible inter-module interconnection, enhancing the overall system's energy efficiency and operational reliability while ensuring computational performance. In some embodiments, FIG. 5 exemplifies a cubic module integration.

In some embodiments, the Memory Fusion Computing architecture distributes computing units, memory units, and logic units across multiple vertically stacked chips in a three-dimensional structure or on a single two-dimensional planar chip, based on functionality and usage requirements.

For example, for highly parallel, high-throughput matrix multiplication (e.g., AI inference), a three-dimensional tightly-coupled Memory Fusion Computing architecture may be employed. This involves distributing the memory units responsible for storing weight data directly above and below the chip layer containing the computing units, forming a vertical stack. Logic units for scheduling and data routing are distributed on the same layer as the computing units.

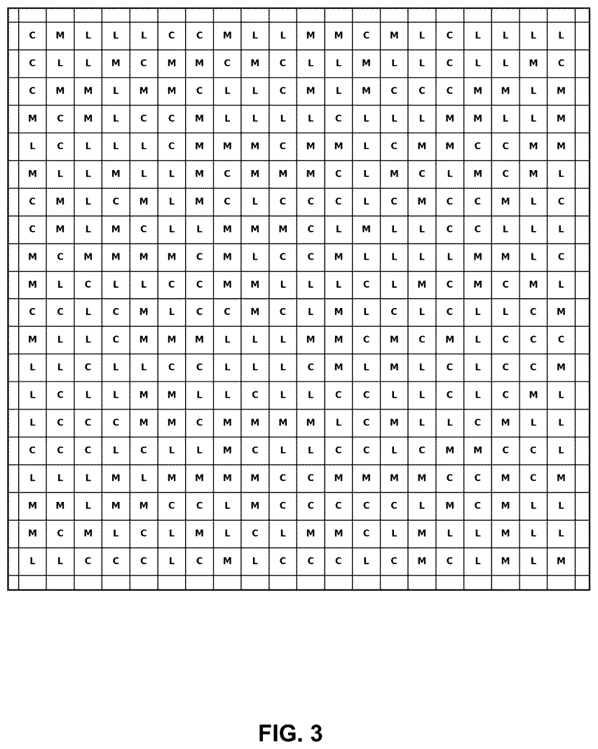

FIG. 3 is a schematic structural diagram of a Memory Fusion Computing architecture according to some embodiments of the present disclosure. As shown in FIG. 3, ‘M’ represents a memory unit, ‘C’ represents a computing unit, and ‘L’ represents a logic unit. Memory and computing functions appear “fused” within the FGC modules, thereby forming the Memory Fusion Computing architecture.

In some embodiments, data transmission between FGC modules, as well as between FGC modules and the central scheduling module, is performed via a data interaction protocol. For details regarding the central scheduling module, please refer to the relevant description below.

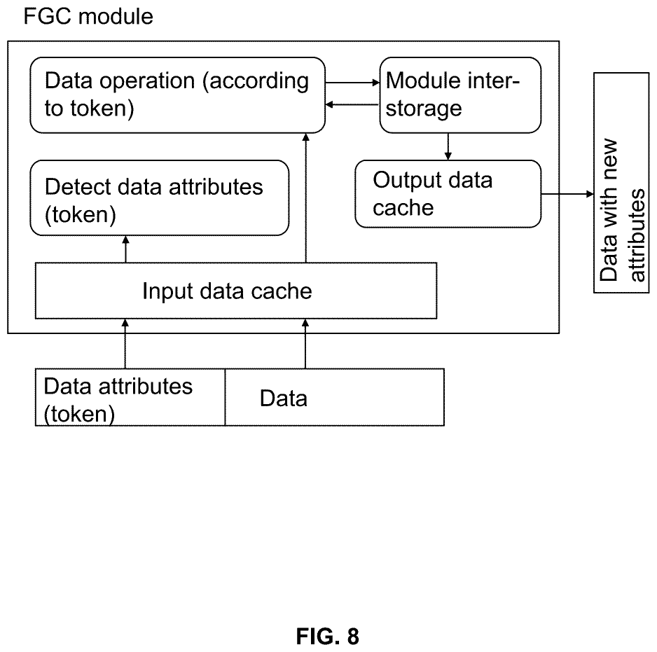

In some embodiments, the data interaction protocol dynamically determines and schedules data flow paths by adding data attributes to input data to the plurality of FGC modules or modifying data attributes of output data from the plurality of FGC modules. Data is transmitted between the FGC modules by establishing connection paths. For more details on the data attributes, please refer to FIG. 8 and its associated description.

Within an FGC module, the various functional units may be implemented as a 2D circuit structure or a 3D circuit structure depending on their layout within the module and interconnect density. Units employing the 3D circuit structure achieve multi-layer stacking and interconnection through Through-Silicon Vias (TSVs) and other high-density interconnect technologies, while units using the 2D circuit structure communicate via metal layers within the wafer. The FGC architecture in FIG. 2 adopts a cubic packing scheme, where the address of each FGC module is represented by three coordinates, for example, an FGC 000 module, an FGC 001 module, and an FGC 011 module shown in FIG. 2.

Using the FGC 000 module as an example, its operational principle is described as follows:
When external data enters the FGC 000 module, it is first stored in a cache module (e.g., Cache 03) for buffering. Based on the data interaction protocol, the logic unit determines whether the data needs to be processed within the current module or transmitted to other idle modules.
When the module is idle: an attribute portion of the data enters a logic unit within FGC 000 for evaluation. A multiplexer (MUX) circuit is used to select the operation required for the data. A data portion of the data enters a high-performance parallel computing unit (CMP) for processing. After computation is complete, the result is stored in an adjacent memory unit (MEM). A decision is made, according to the data interaction protocol, on whether to keep the data stored in the MEM or to have it re-enter the computing unit to have attributes appended before being transmitted to other FGC modules. If transmission is required, the data with its attributes is sent to a target module via an adjacent cache module (e.g., Cache 01).
When the module is busy: if the current module is busy and local computation is not required (i.e., the computation is parallel rather than serial), data request instructions are sent to surrounding modules (e.g., six adjacent modules, adjustable based on actual design) in a random order. If an idle module is identified, the data is transferred directly from Cache 03 to Cache 02 and then forwarded to the idle module in a next layer.

Each FGC module is capable of autonomous computation, storage, and logical decision-making. The entire process strictly adheres to the data interaction protocol, eliminating the need for centralized management by an external master controller.

The data interaction protocol for data interaction between FGC modules (also referred to as an inter-FGC module data interaction protocol) is a core component of the 3D AI processor system (e.g., an FGC processor system), governing all interactive behaviors between FGC modules and with external data. Through the data interaction protocol, the processor FGC system achieves high-efficiency, low-latency data transmission, ensuring the coordination and stability of the entire processor system.

The 3D power supply circuit refers to a circuitry used to provide electrical power to the processor system.

In some embodiments, the 3D power supply circuit may be designed to conform to the three-dimensional stacked structure of the FGC array, providing the necessary power to the individual FGC modules within the FGC array. The 3D power supply circuit may perform low-power optimization by powering down idle FGC modules within the FGC array or activating substitute FGC modules.

In some embodiments, the 3D power supply circuit adopts a distributed power delivery scheme, providing independent power management for each of the plurality of FGC modules through a multi-layer power network. Due to the scalable nature of the FGC architecture, a portion of the plurality of FGC modules may be unused. In such cases, the central scheduling module detects the unused FGC modules and cuts off their power supply to reduce energy consumption.

In 3D circuits, power is delivered from a bottom chip layer to upper layers, accomplished via TSVs and vertical inter-layer interconnect materials (e.g., copper, solder bumps, etc.). In some embodiments of the present disclosure, to mitigate voltage drop during the delivery process, the 3D power supply circuit is optimized to ensure power supply voltage stability for top-layer FGC module(s) even under constrained size conditions.

The data management module refers to a module configured to perform data communication with an external device.

The data management module is primarily responsible for data communication between the FGC modules and external devices or internal systems. Acting as a bridge and coordinator, the data management module ensures efficient and stable data interaction between the FGC modules and external devices, internal systems, and other hardware components.

As shown in FIG. 2, external data is input into a cache module via a high-speed data receiving channel. Subsequently, the central scheduling module, based on the data interaction protocol, adds data attributes to all raw data and transmits the attributed data to a target location in a bottom-layer FGC module (e.g., an FGC module with coordinates xy0, where x and y are constants). The data management module supports multiple communication protocols (e.g., SerDes, PCIe, UCIe), ensuring compatibility with most modern devices.

An external device refers to other hardware components, systems, or devices that engage in data interaction with the FGC processor. Exemplary external devices may include a storage device, a network interface device, an input/output device, or the like.

The central scheduling module refers to a module configured to manage and coordinate the FGC modules.

In some embodiments, the central scheduling module is configured to perform corresponding functional configuration of the plurality of FGC modules based on the data interaction protocol, configure data attributes, authorize a selected count of FGC modules according to a hierarchical management mechanism, and monitor a portion of the authorized FGC modules.

The primary functions of the central scheduling module are as follows: 1) configuring functions of the FGC modules, for example, designating candidates for group leader(s) in a hierarchical management mode, or powering down/activating FGC modules based on low-power considerations or differing application requirements; 2) adding attributes to externally input raw data; 3) removing attributes from output data; 4) accurately transmitting the attributed data to bottom-layer FGC module(s) and receiving computation results output from the bottom-layer FGC module(s); and 5) enabling high-speed data interaction with the data management module. Furthermore, the central scheduling module utilizes the hierarchical management mode to monitor a usage status of the top-layer FGC module(s) in real-time, which can prevent the system from entering a deadlock or other timing errors, and power down unused modules to further reduce energy consumption.

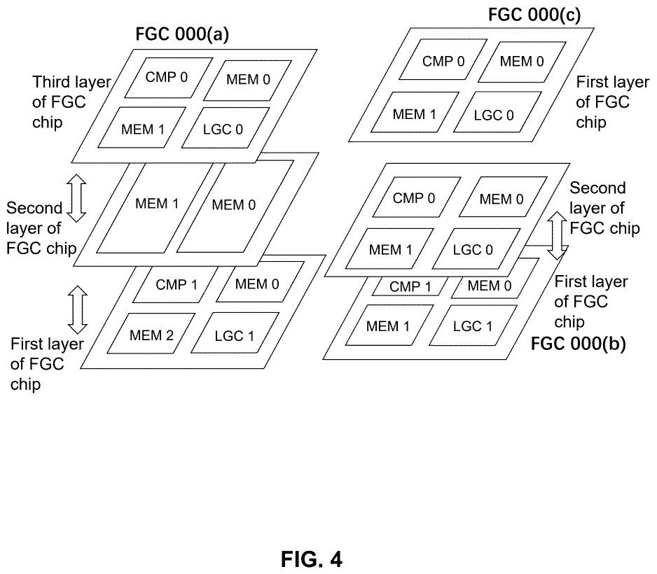

FIG. 4 is a schematic diagram illustrating different structural implementations of an FGC module according to some embodiments of the present disclosure.

As shown in FIG. 4, additional implementation forms of the FGC modules are supplemented. It should be noted that the FGC modules based on the Memory Fusion Computing architecture is not limited to the specific embodiments described in the present disclosure; its structural form may be adjusted and optimized according to different application requirements.

An FGC module based on the Memory Fusion Computing architecture integrates computing unit(s), logic unit(s), and memory unit(s) internally. The computing unit performs data operations, such as multiplication, addition, non-linear computation, etc. The logic unit determines a type of operation to be performed on data based on data attributes of the data. The memory unit stores externally input data, data generated during computation, and computation results. Physically, each FGC module may reside on a single chip layer or span multiple chip layers (e.g., 2-3 chip layers). Concurrently, the internal computing unit(s), memory units(s), and logic unit(s) may also be located on a single chip layer or span multiple chip layers, depending on different application requirements and the specific topology (e.g., a cubic topology) implemented for the FGC module array. Furthermore, as different neural network models have varying demands for data storage and computation, the count, ratio, and distribution of the computing unit(s), the memory units(s), and the logic unit(s) within an FGC module may be adjusted to optimize computational efficiency.

FIG. 4 shows three different internal structures of an FGC module, designated as FGC 000(a), FGC 000(b), and FGC 000(c). FGC 000(a) is distributed across a first layer, a second layer, and a third layer of an FGC chip. FGC 000(b) is distributed across the first and second layers of the FGC chip. FGC 000(c) module is distributed on the first layer of the FGC chip. The units within the FGC module may be located on a single chip layer, such as Computing Unit 0 (CMP 0) and Logic Unit 1 (LGC 0) in the FGC 000(a), and Computing Unit 0 and Logic Unit 0 in the FGC 000(c). Units within an FGC module may also span multiple chip layers, such as Memory Unit 0 (MEM 0) in the FGC 000(a) spanning three chip layers, Memory Unit 1 spanning two chip layers, and Memory Units 0 and 1 in the FGC 000(b) span two chip layers. An FGC module may have multiple types of functional units on a given layer, or only one type of functional unit. For example, the FGC 000(a) has only memory units on the second layer of the FGC chip, while the FGC 000(b) has computing, memory, and logic units on the first layer of the FGC chip.

It should be noted that the foregoing descriptions of the FGC processor and its modules are merely for illustrative convenience and shall not be construed as limiting the present disclosure to the exemplified embodiments. It will be appreciated by those skilled in the art that, upon understanding the principles of the processor system, various modules may be arbitrarily combined, or form subsystems connected with other modules, without departing from these principles.

In some embodiments, the FGC processor may be applied as a main processor, a co-processor, an embedded processor, a heterogeneously integrated Chiplet, or embedded as a standalone IP core into a target platform.

FIG. 5 is a conceptual diagram of a 3D AI processor based on an FGC architecture according to some embodiments of the present disclosure.

Embodiments of the present disclosure provide a method for designing a 3D AI processor based on an FGC architecture (also referred to as the FGC processor). The method is applied to the 3D AI processor based on the FGC architecture, i.e., the FGC processor.

The method may include the following steps:

### S1. FGC Architecture Design:

In some embodiments, the FGC architecture design includes an FGC array design, including designing a topology structure for a 3D stacked distribution of FGC modules according to different application requirements and applicable scenarios.

The FGC architecture is based on a plurality of three-dimensionally stacked FGC modules. Each FGC module is capable of functions such as computing data, storing data, and performing logical judgment. The FGC modules communicate with each other based on an FGC data interaction protocol, forming a scalable three-dimensional stacked structure (also referred to as an expandable three-dimensional layout).

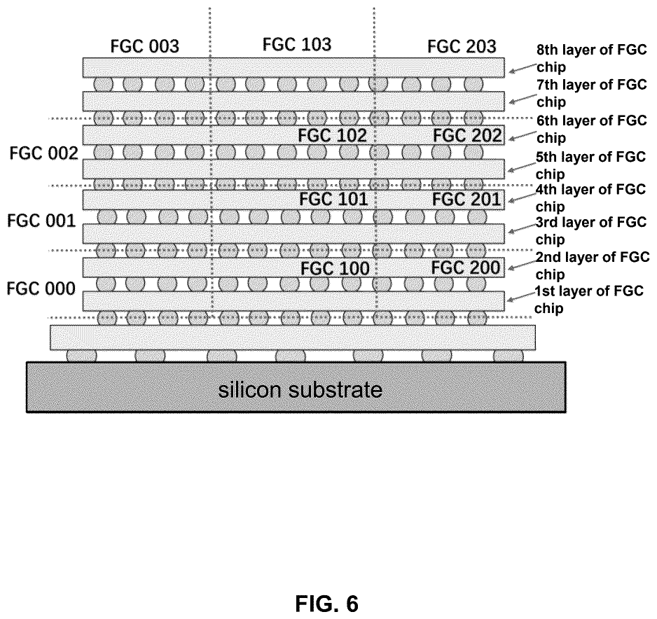

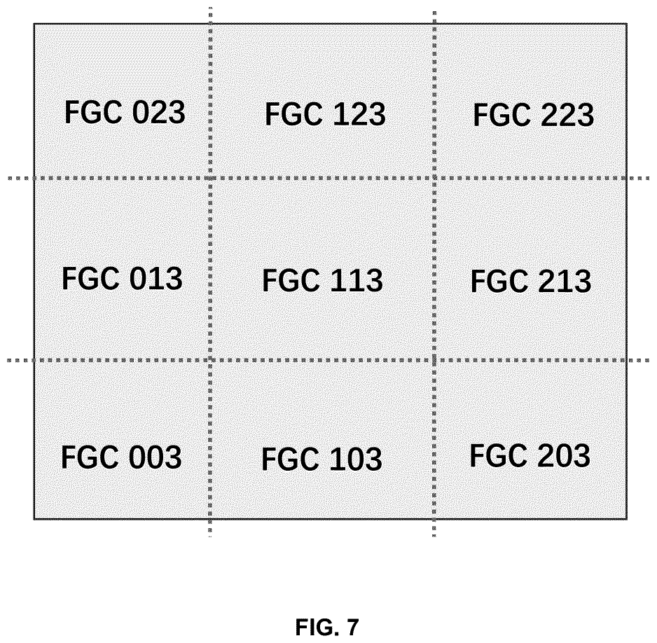

Schematic diagrams of the FGC processor system structure are shown in FIG. 6 (exemplifying a 3*4*3 array of FGC modules, where FGC 000 represents an module with relative coordinates 000, and similarly for modules at other coordinates) and FIG. 7 (exemplifying a 3*4*3 array of FGC modules, where FGC 003 represents a module with relative coordinates 003, and similarly for modules at other coordinates). An overall schematic diagram of the FGC architecture is shown in FIG. 2.

FIGS. 6 and 7 only show examples of an FGC processor composed of 36 FGC modules; however, the present disclosure is not limited to a specific count of FGC modules. In practical applications, the count of FGC modules may be dynamically adjusted based on computational requirements.

FIG. 5 illustrates an embodiment of the FGC architecture, in which computing unit(s), memory unit(s), and logic unit(s) are miniaturized into individual independent FGC modules, respectively. This enables multiple FGC modules to form a scalable cube structure in terms of computational logic and a stacked three-dimensional chip in terms of physical structure. The computing unit(s) are configured to perform data operations, the memory unit(s) are configured to store data, and the logic unit(s) are configured to determine the type of operation to be performed on data. This design significantly enhances the parallel data processing capabilities of both computation and memory while ensuring system flexibility.

Within the FGC architecture, the internal functional units of each FGC module collaborate closely through efficient layout and routing within the same chip layer, and achieve high-speed data transmission between different chip layers via high-density interconnect technologies, ensuring the efficient execution of computing and memory tasks. Each FGC module may be distributed across multiple chip layers, enabling the computing unit(s), the memory unit(s), and the logic unit(s) of the FGC module to perform parallel processing across multiple levels. This design not only fully utilizes the spatial advantages of 3D packaging technology but also significantly reduces communication latency and improves data exchange efficiency.

The FGC array is a core computing component of the FGC processor, formed by a plurality of FGC modules arranged in an expandable three-dimensional layout.

In some embodiments, the FGC array is formed by vertically stacking multiple chip layers (i.e., individual silicon dies), where each chip layer contains the functional units of multiple FGC modules. Interconnected FGC modules may transmit data in a vertical direction and a horizontal direction. For more details on data transmission, please refer to Step S2 and the related description.

The FGC module internally employs a Memory Fusion Computing architecture, which may be used to deeply integrate the functions of computation, memory, and logical judgment. Each FGC module includes one or more computing units, one or more memory units, and one or more logic units. For more details on the FGC module, refer to FIG. 2 and the related description.

By deeply integrating computing units and memory units, some embodiments of the present disclosure propose a new design concept fundamentally different from the current mainstream Computing-In-Memory (CIM) and Near-Memory Computing schemes, termed the Memory Fusion Computing (MFC) architecture. The MFC architecture does not embed computing operations directly within memory units, nor does it rely on placing a complete processor merely in proximity to memory as in conventional Near-Memory Computing approaches. Instead, the MFC architecture is constructed through fine-grained co-design of memory resources, computing resources, and data-scheduling paths, such that computing logic forms a dynamic and localized collaborative relationship with distributed memory units. For further details on the MFC architecture, please refer to FIG. 2 and the related description.

In some embodiments, the topological structure of the three-dimensional stacked distribution of FGC modules may be designed according to requirements. For example, a cubic topology may be adopted for tasks involving high parallelism and regular computations; a ring or honeycomb topology may be used for tasks demanding high reliability and fault tolerance; and a tree topology may be employed for computational tasks requiring fast global aggregation.

Comparison between the FGC architecture provided by some embodiments of the present disclosure and the CIM scheme:
In the CIM scheme, computing devices primarily consist of analog components, and their computation process relies on the manipulation of analog signals. The advantage of the CIM scheme lies in its ability to directly store the results of each computation within the device itself for subsequent use. Currently, large AI models place high demands on both data precision and storage capacity. However, the storage capacity per computing unit in the CIM scheme is limited, typically ranging from a few bits to several tens of bits. Consequently, CIM chips are mainly suitable for data-sparse networks and require additional off-chip Static Random-Access Memory (SRAM) to cache data not immediately involved in computation. Since the computed data in CIM is analog while the data stored in SRAM is digital, CIM involves extensive use of Analog-to-Digital Converter (ADC) and Digital-to-Analog Converter (DAC) modules for data input and output, and faces challenges related to insufficient data storage precision. These additionally introduced analog-to-digital conversion circuits partially offset the area advantage of CIM devices. Furthermore, data interaction between the CIM chip and the off-chip SRAM still relies on the von Neumann architecture, limiting the performance gains potentially achievable through the CIM device's high-speed computation. Regarding computation control, the CIM chip, acting as a parallel computing accelerator module, depends on instruction control from an off-chip CPU. Computation results need to be transferred to the CPU for subsequent processing, thus becoming constrained by the off-chip CPU's bandwidth. Additionally, in terms of manufacturing process, although CIM is largely compatible with CMOS technology, it still faces challenges in manufacturing uniformity and reliability, impacting its application in large model training.

Comparison between the FGC architecture provided by some embodiments of the present disclosure and the Near-Memory Computing scheme:
The core concept of Near-Memory Computing is to reduce data movement costs and thereby enhance data processing efficiency by shortening the physical distance between the CPU and memory. A common implementation of Near-Memory Computing involves splitting a large CPU into multiple smaller CPU cores, with memory units distributed near these smaller cores, enabling data processing to be completed locally as much as possible. These small CPU cores interact data through advanced packaging technologies and manage data flow via a multi-core CPU architecture. Although the Near-Memory Computing scheme reduces data interaction latency to some extent, its architecture is still based on the traditional memory architecture and constrained by the bandwidth limitations of the data bus, address bus, and control bus. Consequently, while Near-Memory Computing alleviates the memory wall and memory bandwidth bottleneck, its energy efficiency and scalability remain limited, making it difficult to completely break free from the constraints of the von Neumann architecture.

Comparison between the FGC architecture is provided by some embodiments of the present disclosure and the GPU solution:
A high-performance GPU paired with a general-purpose CPU currently represents the most common AI platform. The CPU typically serves as the control center for data scheduling and operational workflows, responsible for task management and peripheral interaction. The GPU, leveraging its massively parallel computing cores, handles core computational tasks such as matrix multiplication-addition and convolution. To enhance processing efficiency, GPU platforms widely adopt specialized data optimization strategies (e.g., data reuse, on-chip caching, pipeline scheduling). However, they fundamentally still adhere to the von Neumann architecture, where computing and memory are physically separate, utilizing external video memory (VRAM). As model sizes employing GPU solutions continue to grow, vast amounts of data (e.g., weights, activation values, error signals, etc.) need to be frequently moved between the GPU and external VRAM, leading to the “memory wall” bottleneck and incurring significant latency and power consumption overhead.

The advantage of using a GPU solution lies in the Turing completeness of the general-purpose CPU, enabling easy implementation of different network model architectures. GPU solutions hold inherent advantages for implementing small neural networks but face multiple limitations when dealing with large-scale neural networks. Firstly, external memory access latency is difficult to avoid; even with High Bandwidth Memory (HBM), data transfer must occur via a bus, resulting in persistently high latency and power consumption. Particularly in GPU cluster environments, multiple GPUs must rely on buses or interconnection networks (e.g., PCIe, NVLink, or InfiniBand) for large-scale data exchange. This creates substantial communication overhead, where device communication and data synchronization lead to highly concentrated energy consumption and significantly increased total power draw. This not only causes a notable increase in thermal management pressure but also further reduces the system's energy efficiency ratio. Secondly, although GPU computing cores are numerous in quantity, their actual utilization is constrained by instruction pipelining and task scheduling. When faced with different network architectures, the hardware potential cannot be fully realized, leading to core idling phenomena. The concentrated power density of GPUs is unsuitable for the thermal constraints within 3D stacking, and CMOS processes are approaching physical limits, making further performance enhancements difficult.

Comparison between the FGC architecture provided by some embodiments of the present disclosure and Neural Network Accelerators (e.g., Neural Processing Unit (NPU) or Tensor Processing Unit (TPU)):
Existing neural network accelerators (e.g., NPUs, TPUs, etc.) primarily enhance computational efficiency and energy efficiency ratio through arrayed matrix computation units (e.g., systolic arrays) and on-chip caches. Such architectures exhibit high parallelism when executing large-scale matrix multiplication-addition operations and demonstrate favorable performance in specific AI tasks (e.g., convolution, fully-connected computations). However, these neural network accelerators still fundamentally rely on an instruction-driven, centralized control model, where a central control unit is responsible for scheduling computations and data transfers, resulting in insufficient module autonomy. When the network scale increases or the topology changes, frequent reliance on the controller for global scheduling becomes necessary, limiting system flexibility and scalability.

Furthermore, although NPUs/TPUs integrate on-chip Static Random-Access Memory (SRAM) or dedicated caches to reduce some memory access overhead, they still require frequent access to off-chip memory during large-scale model computations, introducing bandwidth bottlenecks and high power consumption issues. In high-concurrency scenarios, instruction pipelining and cache scheduling also introduce additional overhead, further reducing acceleration efficiency.

Comparison between the FGC architecture is provided by some embodiments of the present disclosure and Photonic Neural Network Accelerators:
The core concept of Photonic Neural Network Accelerators is to utilize optical devices (e.g., micro-ring resonators, optical interference arrays) to perform matrix multiplication, aiming for advantages in high speed and low latency. However, they still exhibit shortcomings in practical applications. Firstly, photonic chips have a relatively large footprint and limited integration density, making it difficult to achieve high-density stacking comparable to electronic chips. Secondly, the optical computation process still relies on Analog-to-Digital (AD) and Digital-to-Analog (DA) conversion to frequently switch data between the electronic and optical domains. This not only increases energy consumption and latency but also partially offsets the speed advantages of optical computing. Thirdly, although the operational speed of optical computing units is very high, they lack a local memory hierarchy (e.g., registers, on-chip cache, video memory) that can match this speed. This results in data access speeds being far lower than data computation speeds, creating a performance bottleneck where computation is constantly waiting for data. Finally, optical devices are highly sensitive to ambient temperature, optical signal noise, and process variations, making them susceptible to external interference that affects computational stability, and posing challenges for ensuring long-term reliable operation in large-scale systems.

### S2. Fine-Grained Cube (FGC) Module Design:

In some embodiments, the FGC module has a three-dimensional stacked structure. When designing the 3D stacked structure for the computing units, the memory units, and the logic units, a tightly integrated layout based on the Memory Fusion Computing architecture is adopted. A distribution of each functional unit may be chosen as a single-layer distribution (i.e., distributed on a single layer) or a distribution across multiple chip layers (i.e., spanning multiple chip layers), depending on application requirements. For more details on the three-dimensional stacked structure, please refer to FIG. 2 and its related description.

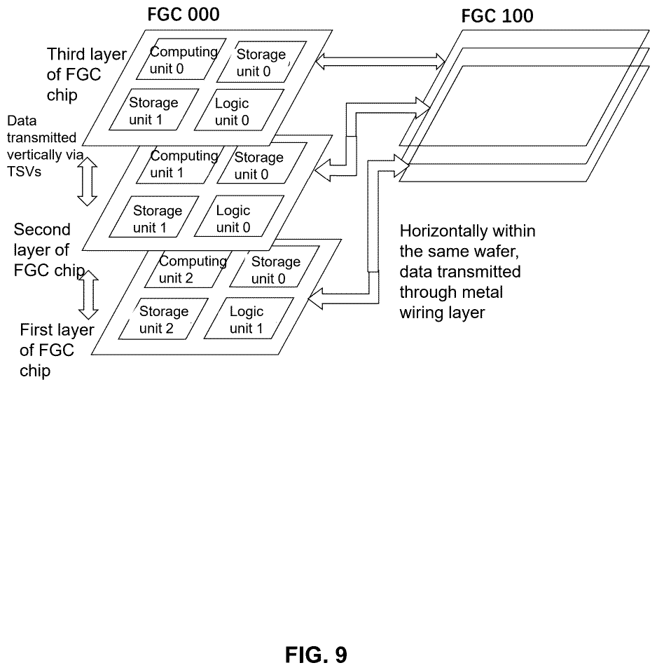

The FGC module employs a small, modular design, distributing computing units, memory units, logic units, etc., across a single chip layer or multiple stacked chip layers. A schematic diagram of the internal structure of an FGC module is shown in FIG. 9, using FGC 000 and FGC 100 as examples, where the count and arrangement of logic units, memory units, and logic units are for illustrative purposes only. Within FGC 000, data is transmitted between its multiple internal layers or between vertically adjacent, different FGC modules via TSVs. Between FGC 000 and FGC 100, i.e., between different FGC modules located horizontally on the same wafer, data is transmitted through metal wiring layers.

A single functional unit may span multiple chip layers (e.g., 2-3 layers). Therefore, dedicated testing strategies are required for each chip layer to ensure its correctness and stability. Concurrently, depending on different application requirements (such as computational capability or performance demands), the system scale may be flexibly expanded or reduced by increasing or decreasing the count of FGC modules—that is, by scaling the cube structure illustrated in FIG. 5—without significantly modifying the data interaction protocol or other control mechanisms between modules. Within an FGC module, input data, based on its data attributes, enters the corresponding data stream in the logic unit for computation. The computation results may be directly stored in adjacent memory unit(s), awaiting subsequent operations or transmission to other FGC modules. The primary control and decision-making within an FGC module are completed autonomously by the module itself, without relying on an external controller for instruction scheduling or requiring long-distance data transfer to external memory. This architecture effectively breaks through the “memory wall bottleneck” and significantly improves computational efficiency. By reducing the complexity of individual functional modules and increasing the count thereof, the memory and computing functions appear to be “fused” within the FGC module, thereby forming the Memory Fusion Computing architecture. As shown in FIG. 3 (provided for illustrative purposes only; the actual unit layout may not strictly follow this structure), the layout manner may be determined by a mathematical model at a circuit upper level, deciding the count and arrangement of modules or units based on the computational and storage requirements of specific data operation steps. The aforementioned design not only enhances data access efficiency but also enables the system to flexibly scale computing and memory resources according to specific application needs, supporting large-scale parallel computing tasks and meeting the demands of high-performance AI computing.

### S3. Inter-FGC Module Data Interaction Design:

In some embodiments, the data interaction protocol is designed by adding data attributes to input data to the plurality of FGC modules and modifying data attributes of output data from the plurality of FGC modules, to achieve scheduling control of data flow paths, wherein the plurality of FGC modules execute corresponding operations on the data based on the data attributes; and performing authorized management of the plurality of FGC modules according to a hierarchical management mechanism, wherein the central scheduling module grants group leader authority to a selected count of FGC modules, and the FGC modules granted the group leader authority monitor data flow states of FGC modules in adjacent regions to prevent excessive divergence of data flow.

One of the core advantages of the FGC architecture is the efficient data interaction protocol between FGC modules. To achieve high-speed data transmission between modules, the coordination and transfer of data rely on a highly efficient, low-latency data interaction protocol. The data interaction protocol provided by some embodiments of the present disclosure is a dedicated data flow path and scheduling algorithm that optimizes transmission paths between modules, significantly reduces data latency, and enhances overall computational efficiency. The core of the path protocol (i.e., the data flow paths) involves adding attributes (tokens) to the data. Raw data input into the FGC chip initially has data attributes added within the bottom-layer chips to control the subsequent flow of the data, as shown in FIG. 8.

Data attributes refer to specific attributes appended to data transmitted from external devices or between FGC modules. The data attributes include one of a data type attribute, a layer attribute, or an operation attribute, or any combination thereof.

In some embodiments, the data attributes typically include the following: (1) the data type attribute: indicating whether the data is input data, output data, network weights, biases, feature map data, etc.; (2) the layer attribute: indicating a layer of a neural network in which the data is located; (3) the operation attribute: specifying an operation performed on the data within the plurality of FGC modules, the operation including multiplication, addition, non-linearization, etc.; (4) other parameters (modified according to different neural network modules), for example: special operations to be performed on the data within the FGC modules, such as feedback data in a Recurrent Neural Network (RNN); an address of the data within a current FGC; potential output address(es) for the data; check signals added to ensure correct transmission, etc.

The data attributes exist as a prefix to the data and enter the FGC module together with the data for processing. When attributed data enters an FGC module, a logic unit detects its attributes to determine the operation to be performed. If the current FGC module is busy, the data is dispatched to other FGC modules for processing. If the FGC module is idle, the data is handed over to the computing unit for processing. The result is then stored in a nearby memory unit to await subsequent computation or, with new attributes attached, output to a new FGC module for continued processing.

Another mechanism included in the data interaction protocol is a hierarchical management mechanism, which refers to a management strategy for efficiently coordinating FGC modules.

In some embodiments, the hierarchical management mechanism involves managing FGC modules in a tiered structure. The central scheduling module performs hierarchical management on the FGC modules, authorizes a selected count of FGC modules with a corresponding distribution via the central scheduling module, and the authorized FGC modules are configured to monitor and regulate operations of unauthorized FGC modules in adjacent regions of the authorized FGC modules to prevent excessive divergence of data flow. The authorization includes granting a plurality of different levels of management authority, and management modes include step-by-step management and cross-level direct management.

In some embodiments, the central scheduling module performs configuration on the specific FGC modules via the data interaction protocol, granting them specific levels of management authority. For example, based on the topology of the FGC array and the current computational task, the central scheduling module may select at least one FGC module that possesses a relatively optimal data exchange path in terms of physical layout, designate the at least one FGC module as an FGC management module or a “group leader,” and grants the at least one FGC module corresponding authority.

An FGC management module refers to an FGC module that has been authorized by the central scheduling module. The FGC management module is configured to monitor and regulate the operation of FGC modules in its adjacent region. When necessary, the FGC management module dynamically adjusts the task load of FGC modules by scheduling and migrating data stored across multiple FGC modules, thereby keeping the FGC modules in an effective working state as much as possible and avoiding idleness or task overload.

In some embodiments, an authorized FGC module (i.e., the FGC management module) uses its logic unit(s) to monitor, in real-time, the operational status of other FGC modules in its adjacent region. The monitored content may include, but is not limited to, a busy/idle status of these FGC modules, an occupancy rate of internal computing resources, and cache usage.

In some embodiments, the level of management authority may manifest as the count of FGC modules that can be managed, the scope of controllable resources, and the priority of scheduling operations. For example, a higher-level FGC management module is capable of coordinating and orchestrating multiple lower-level FGC management modules or ordinary FGC modules under its supervision, including adjusting their operational status, resource allocation, and data flow. In contrast, a lower-level FGC management module may only manage the modules directly subordinate to it and must respond to assignments or coordination instructions from higher-level management modules. Different levels of management authority may be defined based on the role of the authorized FGC module within the hierarchical management mechanism, such as a primary group leader or a secondary group leader.

In some embodiments, the management modes of the hierarchical management mechanism may include step-by-step management and/or cross-level direct management, or the like.

The step-by-step management refers to a management mode where management authority and data flow are transmitted layer by layer from top to bottom, ensuring orderliness and stability in management. For example, in a multi-level FGC array, an FGC module with a relatively high level of management authority issues management requirements or scheduling decisions to its directly subordinate relatively lower-level FGC modules. These lower-level modules, in turn, further manage the next level of FGC management modules or ordinary FGC modules under their jurisdiction.

The cross-level direct management refers to a management mode where an FGC module with a relatively high level of management authority may, when necessary, directly monitor or regulate ordinary FGC modules without going through intermediate levels. For example, in situations where certain tasks are more suitable for direct coordination by a higher-level module, a higher-level FGC management module or the central scheduling module may issue management operations directly to any ordinary FGC module, thereby simplifying the management path or improving processing efficiency.

The aforementioned management methods are merely examples. Specific management manners may be selected based on the application scenario, the count of available FGC modules in the system, or operational requirements, or may be configured or switched among when multiple management manners are available. Embodiments in the present disclosure do not require that all these management manners be present simultaneously, nor are they limited to only these manners. In practical applications, a specific management manner may be chosen for operation according to actual needs; in implementations with multiple management manners, switching between different manners may also be performed based on changes in task type, system load, or topology. For example, in some application scenarios, the step-by-step management may be used to maintain the stability of the management structure; in other scenarios where direct coordination by higher-level modules is more suitable, the cross-level direct management may be adopted to improve processing efficiency. It should be noted that these management manner and their application scenarios are provided as examples only and do not limit the possible implementations.

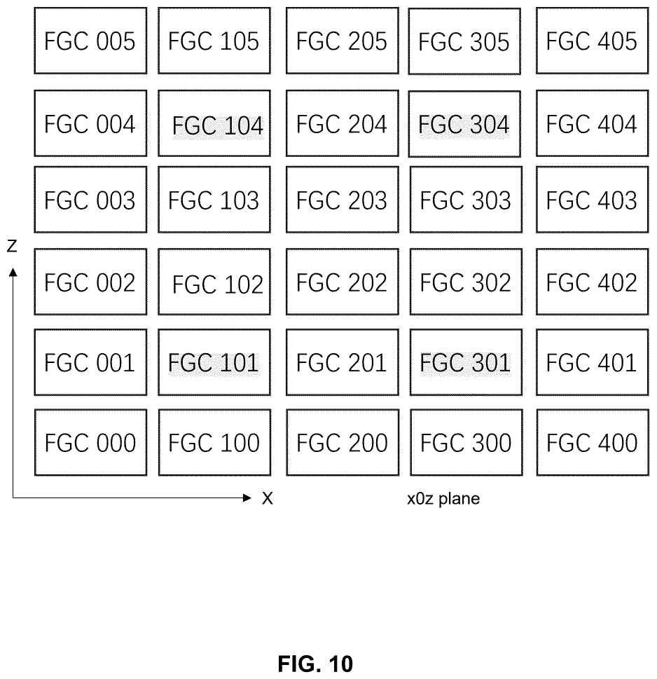

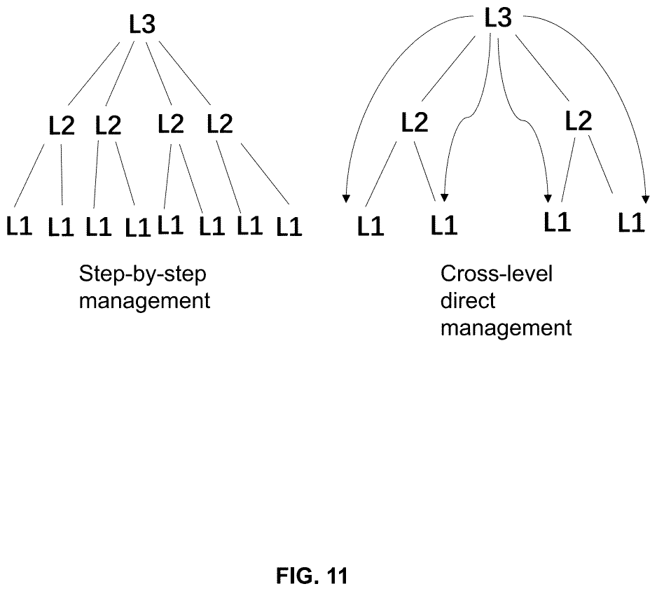

In some embodiments, although the FGC modules are fully reusable, higher levels of management authority are granted to a portion of the FGC modules of the FGC array to coordinate nearby FGC modules and proactively schedule data, preventing excessive data dispersion. When it is detected that some FGC modules become busy due to increased data volume, FGC management modules with higher levels of management authority may temporarily migrate data from their input buffers to other idle or low-load FGC modules for execution, thereby achieving load balancing and avoiding local congestion. As shown in FIG. 10, the horizontal x-direction takes values from 0 to 4, the vertical z-direction takes values from 0 to 5, and four FGC modules (marked in grey background) are selected as group leaders in the x0z plane. The FGC management modules (i.e., the “group leaders”) are configurable, and a physical distribution of the FGC management modules may be spaced at a preset distance uniformly to manage more FGC modules. In an FGC module plane shown in FIG. 11, modules FGC 104, FGC 304, FGC 101, and FGC 301 are set as Level 1 (L1) group leaders to assist in processing or coordinating the output data of multiple FGC modules within their jurisdictions (e.g., eight in this 2D array example, similarly for a 3D array) nearby FGC modules. For example, in a structure where output data is centrally managed for sending to target FGC modules, an FGC management module may integrate output data from multiple FGC modules; in a structure where FGC modules actively manage output data to target FGC modules, the FGC management module does not need to integrate data but instead coordinates data transmission paths to avoid congestion. When neural layer data becomes excessively dispersed, coordinated processing of relevant neuron data may be performed as needed, and some data may be directed to one or more adjacent FGC modules to maintain the coherence of data flow and prevent local load imbalance. Since the FGC array itself is scalable and contractible, the count and levels of group leaders in the hierarchical management mechanism may increase as the count of modules grows. Concurrently, considering application to different neural network models, the hierarchical management mechanism may also be adapted, as exemplified by the two management type examples shown in FIG. 11. The FGC modules themselves are reusable, and an FGC management module may be activated or deactivated using a multiplexer (MUX) circuit within the FGC module's logic unit. Activation and deactivation via the MUX circuit may be uniformly configured in advance by the central scheduling module in a layer-0 FGC chip before computation begins. This configuration process does not participate in computation and therefore does not impact in-memory computing performance. Moreover, the FGC management modules themselves still perform data computation and storage tasks, merely occupying a portion of spatial resources for system-wide data coordination. It should be noted that the data interaction protocol abandons the traditional system bus design, enabling each FGC module to operate independently without relying on a central controller for global scheduling. The aforementioned design further simplifies system complexity while providing robust support for highly efficient data processing.

In some embodiments, an FGC module and its corresponding FGC management module may maintain real-time interaction for dynamically reporting operational status and receiving management scheduling. To further enhance the overall scheduling flexibility of the system, the hierarchical management mechanism may also support adjusting the mapping relationship between an FGC management module and the FGC modules it manages within a preset update cycle. This mapping relationship may be updated based on health data, physical location, or other relevant information of the multiple FGC modules, thereby forming multiple management sub-regions and determining the FGC management module corresponding to each management sub-region. The central scheduling module ultimately grants authority to the FGC management modules.

In some embodiments, the central scheduling module may, within each preset update cycle, re-divide or merge management sub-regions based on the health data, physical location, or other relevant information of the multiple FGC modules, and accordingly assign or adjust the corresponding FGC management modules. The preset update cycle may be flexibly configured according to system scale or design requirements, for example, 100 ms, 1 s, 5 s, etc.

In some embodiments, based on relevant status information of FGC modules returned by FGC management modules, the central scheduling module may perform operations such as powering down or reducing the power consumption of FGC modules that have been unused for an extended period, thereby implementing energy-saving management. For more details on the central scheduling module, refer to FIG. 2 and the related description.

The health data of an FGC module refers to metrics used to assess a real-time operational status of the FGC module. The health data may include a load status, a data flow feature, location information, or the like. The load status may be quantified by a busy/idle time ratio of the computing unit(s) and a storage occupancy ratio of the memory unit(s). The data flow feature may be obtained by statistically analyzing a dynamic range and a value distribution of the data flowing through the FGC module in real-time. The location information refers to the position of the FGC module within the FGC array; the location information for each FGC module is a fixed value and may be represented in the form (x, y, z). The dynamic range refers to the maximum and minimum values of the data flow, and value distribution refers to the values within the data flow and their corresponding frequencies. The data flow feature may be represented in vector form, e.g., (maximum value, minimum value, value1, count1, value2, count2, . . . ).

In some embodiments, a health data monitoring unit may be integrated into the FGC module. The health data monitoring unit may periodically send health data to the FGC management module or, when needed, directly to the central scheduling module. The specific types of health data, collection methods, and reporting cycles may all be flexibly configured according to system design requirements.

A management region refers to a management scope overseen by a single FGC management module. This scope typically comprises a group of FGC modules that are adjacent in physical location or associated in operational status. The manner for delineating management regions is not limited and may be flexibly defined based on system scale, operational status, or scheduling strategies.

In some embodiments, the central scheduling module may perform clustering on the plurality of FGC modules based on their respective health data, location information, or other relevant factors to obtain multiple clusters. Each cluster is then designated as a management region, thereby forming multiple management regions. The grouping manner may be topology-based, based on FGC module state similarity, or employ other suitable classification or aggregation strategies. Different aggregation results may serve as the basis for forming management regions.

In some embodiments, for each management region, the central scheduling module may obtain an evaluation metric for each FGC module within the region via the FGC management module. The evaluation metric relates to factors such as the health data and physical location of the FGC module. The central scheduling module may calculate a reference value for selecting the FGC management module based on these metrics using any applicable technique, such as standardizing the evaluation metrics, averaging them, applying weights, or employing other scoring techniques, to obtain a score for each FGC module. Based on the resulting scores, the central scheduling module may select one of the FGC modules as the FGC management module corresponding to that management region—for example, by selecting the group of FGC modules with the smallest or largest scores as the FGC management module(s).

An evaluation metric refers to an indicator used to score an FGC module, representing its relative suitability within the management process. In some embodiments, the evaluation metric may include the load status of the FGC module, its relative distance to other modules within the management region, the deviation of its data flow characteristics from the regional average data flow characteristics, or other parameters usable to characterize its operational status. The type and calculation manner of these evaluation metrics may be flexibly configured according to system requirements and are not limited to a specific form.

In the embodiments of the present disclosure, by dynamically adjusting management regions and their corresponding modules, the FGC system can flexibly adapt to changing computational loads, thereby improving overall scheduling efficiency and reducing the occurrence of overload in local regions.

In some embodiments, the hierarchical management mechanism may further extend the selection strategy for management modules based on the overall operational status of the FGC array. For example, weight coefficients for multiple evaluation metrics may be determined based on load information, data flow characteristics, or task types of the plurality of FGC modules. A comprehensive evaluation of candidate modules may then be performed based on the multiple evaluation metrics and their weights to determine the FGC management module for the corresponding region. The manner for setting these weights may be flexibly adjusted according to system characteristics and is not confined to a specific algorithm.

The total load data refers to the load status of the multiple management regions and can also represent a statistical result of the load status of the multiple FGC modules within a management region, such as the average load across multiple management regions. The load status of a management region may be obtained by averaging, applying weighted averaging, or employing other statistical techniques on the operational metrics of the FGC modules within the region.

The task type corresponding to the data flow include a computation-intensive task, a memory-access-intensive task, and a lightweight task. The computation-intensive task triggers a large number of high-complexity mathematical operations, such as FP32 matrix multiplication, which may generate significant computational demand and thermal load. The memory-access-intensive task requires frequent reading and writing of large amounts of data, placing relatively high demands on the internal memory units and local data path bandwidth of the FGC modules. The lightweight task primarily involves operations with low computational complexity, such as data rearrangement and activation functions, having minimal impact on computation and temperature.

In some embodiments, the central scheduling module may identify the system task type based on the operational characteristics of the data flow. This identification may be based on the total computational amount, the total memory access amount, a data reuse degree, a data access pattern, or other metrics capable of characterizing computational and memory pressure. For example, in response to a determination that both the total computation amount and the total memory access amount are less than a preset computation threshold, the current data flow is determined to belong to the lightweight task; in response to a determination that at least one of the total computation amount and the total memory access amount is greater than or equal to the preset computation threshold and a ratio of the total computation amount and the total memory access amount is less than a preset ratio threshold, the current data flow is determined to belong to the memory-access-intensive task; in response to a determination that at least one of the total computation amount and the total memory access amount is greater than or equal to the preset computation threshold and the ratio of the total computation amount and the total memory access amount is greater than the preset ratio threshold, the current data flow is determined to belong to the computation-intensive task. In different implementations, the current data flow may be categorized as the computation-intensive task, the memory-access-intensive task, or the lightweight task based on predefined empirical values, threshold ranges, or other judgment rules. The aforementioned classification manner is not limited to specific formulas or parameters and may be flexibly configured according to system requirements.

More descriptions regarding the evaluation metric may be found in related descriptions above. More descriptions regarding the total computation amount and the total memory access amount may be found in related descriptions below.

In some embodiments, the central scheduling module may utilize historical operational data to construct a first feature library, supporting task type identification or FGC management module selection strategies. The first feature library may store statistical results of operational features, load data, memory access characteristics, or other relevant metrics from historical tasks, and may generate reference features or weight information for scheduling decisions based on corresponding historical data. When needed, the central scheduling module may retrieve reference data from the first feature library that is similar to the features of the current task to assist in determining management regions or FGC management modules. For example, in one implementation, features that demonstrated superior computation speed in historical tasks, or those with higher historical weight coefficients, may be selected as references; historical weight coefficients may be composed of historical statistical values from multiple different evaluation metrics; computation speed may refer to the time difference between the data flow entering and exiting a management region. The organizational format and retrieval manner of the aforementioned first feature library may be flexibly configured according to system needs and are not limited to specific algorithms or data structures.

In some embodiments, the central scheduling module may construct a target feature based on the load data and task characteristics of the current task, and retrieve historical features from the first feature library that are similar to this target feature to determine evaluation weights or scheduling strategies suitable for the current task. The manner for determining similarity may employ distance metrics, matching rules, or other applicable techniques, with no specific technique being mandated.

In some embodiments, the central scheduling module can perform normalization processing on each FGC module based on the various evaluation metrics and their weights to obtain a comprehensive score. Depending on the specific evaluation scheme, a selection of FGC modules with higher or lower scores may be chosen as candidates for the FGC management module. According to system requirements, the central scheduling module may also tend to prioritize selecting FGC modules with lower current load or smaller resource occupancy as FGC management modules to ensure overall computational efficiency.

In the embodiments of the present disclosure, the selection rules for FGC management modules may be dynamically adjusted based on the type or operational state of the current task, enabling the selected FGC management module to better adapt to the current task requirements, thereby enhancing overall processing efficiency. The aforementioned selection rules may employ any applicable scheduling strategy and are not limited to specific algorithms.

In some embodiments, the hierarchical management mechanism may further consider the operational environment information of the management regions. For example, the regional temperature trend provided by on-chip temperature sensors may be used as an auxiliary indicator to identify regions that may be under high pressure or subject to thermal constraints. This information may be used to further refine and optimize the management regions or FGC management modules when necessary. The aforementioned temperature information serves only as an optional reference in the scheduling process, with no specific generation or usage method being mandated.

A regional temperature trend may represent the local temperature change situation near a particular management region, such as the average or trend statistically derived from a plurality of on-chip temperature acquisition points. The manner of temperature acquisition and its spatial distribution may be flexibly configured according to system design and does not require temperature measurement for individual FGC modules or management regions.

In some embodiments, temperature-related adjustment conditions may include: a region exhibiting a continuous warming trend over a period of time, or its temperature exceeding an empirically set temperature threshold, etc. For example, the temperature threshold may be set to 70° C. When such adjustment conditions are met, the central scheduling module may choose to modify the management mode for that region—for example, by increasing available low-load regions, adjusting task mapping methods, or reallocating some resources—to alleviate operational pressure in the local area. The specific judgment manner and threshold setting are not limited.

In some embodiments, the central scheduling module may evaluate multiple management regions surrounding a higher-temperature region, considering their physical proximity. For example, among multiple adjacent regions, those with more stable temperature trends, those not exceeding a preset temperature threshold, or those with lighter loads may be selected as candidates for adjustment. As needed, some tasks from the target region may be migrated to candidate regions to form a new combination of management regions. For example, the central scheduling module may divide the overheated region into multiple sub-regions and merge these sub-regions into the nearest candidate adjacent regions respectively, thereby forming new management regions. Here, the count of candidate adjacent regions is the same as the count of sub-regions. The count of candidate regions and the adjustment manner may be flexibly configured according to system requirements and are not limited to a specific algorithm.

In some embodiments of the present disclosure, by adjusting some computational tasks to regions with more stable temperature trends, thermal distribution on the chip can be balanced to some extent, reducing the risk of local areas remaining in a high-temperature state for extended periods. This adjustment strategy can serve as an auxiliary scheduling method and be combined with other strategies based on load or data flow, with no specific implementation being mandated.

In some embodiments, the temperature change trend of a management region may be predicted using temperature-related information collected over a historical period. The historical period may be a duration preceding the current moment, for example, 100 ms, 1 s, 2 s, etc. The temperature-related information may be obtained from temperature acquisition points within the region, which may correspond to multiple FGC modules or multiple management regions. The predicted temperature change trend may be used to assist in determining whether a management region is likely to face an overheating risk, thereby providing a reference for subsequent scheduling strategies.

An adjacent region refers to a region that is physically adjacent or adjacent in communication paths to the current management region. Adjacency may be determined by checking whether regions have a direct connection, share the same upper-level management unit, or have a shorter communication distance.

A target region refers to an adjacent region that does not meet the overheating condition and has a resource load status below a preset load threshold. The preset load threshold may be set empirically. For example, the preset load threshold may be set to 60%.

In some embodiments, the FGC management module may integrate the temperature change trends and load status of multiple adjacent regions. After normalizing these metrics, it forms a comprehensive score and selects one or more adjacent regions as target regions based on the magnitude of the scores. Normalization processing may include techniques such as Min-Max normalization. The weight coefficients for the comprehensive score and the count of target regions may be configured based on experience or system requirements.

The current task data refers to data flows in the cache queue of the FGC modules within the management region. The current task data may be a minimum schedulable computing unit currently executing, or a migratable data packet. In some embodiments, to reduce the load pressure on a local region, the data flows of multiple FGC modules within the management region may be distributed in a balanced manner to multiple adjacent regions.

Merely by way of example, if a management region needs adjustment due to meeting temperature adjustment conditions, and this region contains M FGC modules while there are 3 available target regions, the tasks from the M FGC modules may be evenly distributed to these 3 target regions through methods such as round-robin or weighted distribution. The present disclosure does not limit the specific allocation manner.

In some embodiments of the present disclosure, by enabling the FGC management module in a region meeting temperature adjustment conditions to proactively migrate tasks to target regions with lower surrounding temperature or load, a rapid-response scheduling strategy can be implemented, thereby alleviating or eliminating localized hotspot issues to a certain extent.

In some embodiments, temperature-related information may serve as an auxiliary reference for the status of a management region, used to assess potential hotspot trends in local areas. When new input data arrives, the central scheduling module may adjust the address of the target FGC module to which this data packet is sent, considering the temperature change trend and the complexity of historical load information of the management region. This directs subsequent data packets to regions with lower temperature trends or more balanced loads, thereby balancing the computational distribution within the chip. The temperature change trend is an auxiliary judgment and does not alter the architecture within the FGC array, which relies on data flow for communication.

New input data refers to the raw data packets input from an external system to the FGC array via the central scheduling module. Based on the packet attributes, the FGC module automatically transmits the packet to the cache queue of the target FGC module to await subsequent computational processing, without requiring control from the central scheduling module.

The complexity level of new input data may be determined based on characteristics such as computational operations, data scale, or data density, and is used to assess the potential computational pressure it may introduce. The complexity level may be inferred from information such as the total computational amount, operation types, or data access volume of the new input data. For example, total computational amount may include the count of Floating-Point Operations (FLOPs) or Multiply-Accumulate Operations (MACs) that the new input data might involve during execution. Data access volume may represent the total amount of data (in Bytes) that needs to be read from or written to the storage units of the FGC modules by this new input data.

In some embodiments, the central scheduling module may generate adjustment parameters for data transmission based on the complexity level of the new input data and the operational status of the management regions (such as temperature trends or load conditions). The adjustment parameters indicate which management regions are more suitable for receiving this new input data at the current moment. For example, when a management region has a lower temperature trend or lighter load, the adjustment parameters may cause the new input data to be more inclined to be sent to that region. If the new input data has a high complexity level, the adjustment parameters may also be used to prioritize selecting regions with higher heat dissipation capacity or more abundant resources for reception. The manner for setting the adjustment parameters may be flexibly determined based on experience and is not limited to specific rules.

In some embodiments of the present disclosure, by fully considering the complexity level of new input data and the temperature trends of management regions during its transmission process, the spatial distribution of data within the FGC array can be made more balanced. New input data is more inclined to be allocated to cooler or less loaded regions during distribution, thereby reducing the risk of sustained temperature rise in local areas and enhancing the overall thermal stability and operational reliability of the array. The aforementioned process does not alter the autonomous, data-driven computation execution manner of the FGC modules; it only performs flexible adjustments to the data transmission paths.

Steps S1-S3 accomplish the front-end functional design of the FGC chip, while S4 proceeds with the back-end packaging design.

### S4. Three-Dimensional Stacked Chip Structure Design:

In some embodiments, the FGC chip employs a 3D packaging technology. The 3D packaging technology refers to a packaging and manufacturing method that involves vertically stacking multiple chip layers and utilizing vertical interconnect structures such as through-silicon vias, microbump interconnects, or redistribution layers to achieve electrical connections and functional integration between the chip layers, thereby forming an integrated three-dimensional system.

In some embodiments, 3D packaging technology may be used to vertically stack and system-integrate a plurality of chip layers. Each of the plurality of chip layers is a single silicon die containing functional units of the plurality of FGC modules, and the plurality of chip layers collectively form the FGC array that comprises the plurality of FGC modules. For example, 3D packaging technology includes the use of a copper-copper bonding technology, a hybrid bonding technology, a low-temperature solder technology, or a Through-Silicon Via (TSV) technology to achieve high-density vertical interconnects.

Some embodiments of the present disclosure are based on 3D integrated circuit technology, achieving higher integration density through vertical stacking of processing chips. High-density interconnects between chips are realized using Through-Silicon Vias (TSVs), enabling fast, low-latency inter-layer communication. The 3D stacked design effectively reduces the chip footprint and signal transmission distance while significantly increasing data transmission bandwidth, providing a solid hardware foundation for efficient parallel computing. Furthermore, by rationally arranging modules and optimizing for low power consumption, thermal issues inherent in 3D integrated circuits are effectively mitigated, thereby enhancing system reliability.

Steps S1-S4 complete the foundational design of the FGC chip. Subsequently, S5 involves FGC chip reliability design and low-power optimization.

### S5. Low-Power and High-Reliability Design:

In some embodiments, the 3D power supply circuit is designed to power down idle FGC modules within the FGC array or activate standby FGC modules for low-power optimization. Redundant circuits are incorporated into the FGC modules, enabling automatic switching to other modules or internal functional units to complete substitute tasks in the event of failures in specific FGC modules or their internal functional units. For further details on the 3D power supply circuit, refer to FIG. 2 and the related description.

A redundant circuit refers to a backup circuit with identical functionality introduced in addition to the circuits strictly necessary for performing the basic functions. In some embodiments, when an FGC module or an internal functional unit of an FGC module fails, redundant circuits are used to switch to other FGC modules or internal functional units to complete substitute tasks.

A substitute task refers to a task that needs to be completed by switching to other properly functioning FGC modules or internal functional units due to a failure in the originally assigned FGC module or its internal functional unit.

The FGC architecture places high importance on balancing low power consumption and high reliability during the design process. In large-scale parallel computing tasks, data transmission between computing units and memory units is a primary source of power consumption. Based on the 3D integrated circuit technology, the FGC architecture significantly shortens the distance between processors and memory found in 2D chips through vertical stacking, reducing both the distance and time required for data transmission, thereby decreasing overall system energy consumption. Furthermore, the FGC architecture employs three-dimensional power management technology. A module power-gating logic unit is implemented within each FGC module, which maintains the module in a powered-off state when there is no data input or stored data, thereby reducing system energy consumption. The inter-module data interaction protocol can dynamically adjust power allocation based on different workloads, ensuring the system maintains low energy consumption even during high-intensity computational tasks. This strategy not only extends the device's operational lifespan but also significantly enhances battery life and overall efficiency in scenarios such as mobile devices and edge computing.

The FGC module design emphasizes fault tolerance and redundancy mechanisms. Even if a module fails, the system may still complete substitute tasks through other modules, thereby improving overall reliability. For example, in the FGC 000 module in FIG. 9, assuming Memory Unit 1 (MEM 1) fails, the internal fault tolerance mechanism moves the originally stored data to a neighboring memory unit 0; assuming Logic Unit 0 (LGC 0) fails, Logic Unit 1 (LGC 1) or Logic Unit 2 (LGC 2) are used for computation. The above design provides stable hardware support for high-performance computing and mission-critical applications.

The steps S1-S5 implement the functional, reliability, and low-power design of the FGC chip, and step S6 performs overall optimization design of the FGC chip by re-examining front-end functions and back-end packaging.

### In S6, Optimization Combination of a Front-End Logic Design and a Back-End Packaging Structure Design:

In some embodiments, the front-end logic design adopts the circuit layout from step S2 and a data flow path algorithm from step S3 that are adapted to three-dimensional stacking requirements. The FGC array is designed with a plurality of chip layers, and circuit design takes into account communication latency between the plurality of chip layers. The back-end packaging structure design is performed by optimizing a physical structure of a 3D circuit based on a count of interconnects in the plurality of FGC modules from the front-end design, so as to ensure that requirements for high-density TSV manufacturing are met.

In some embodiments of the present disclosure, a close connection between the front-end chip design and the back-end packaging technology is established. In traditional chip development processes, the front-end logic design and the back-end packaging design are entirely independent stages: the front-end designs modules with full functionality that meet power and thermal requirements, while the back-end handles routing and packaging layout based on these modules. However, this approach faces multiple challenges in 3D integrated circuits, such as concentrated heat dissipation in computing modules limiting stacking capability, and the “bucket effect” caused by compatibility issues between different functional modules, ultimately constraining overall system performance.

In some embodiments of the present disclosure, a solution for collaborative design between the front-end and the back-end is proposed. During the front-end logic design, the circuit layout from step S2 and the data flow path algorithm from step S3 adapted for 3D stacking requirements are adopted. Each FGC module is designed as a single-layer or multi-layer according to the usage scenario, and issues such as communication latency between multi-layer chips are considered when designing logic gates. The back-end packaging layout design then optimizes the physical structure of the 3D circuit based on the count of interconnects in the front-end FGC modules, ensuring requirements for high-density TSV manufacturing are met. This co-design approach enhances chip integration density while simultaneously optimizing thermal performance and reliability, meeting the application needs of high-performance systems.

The steps S1-S6 implement the design of the FGC chip architecture, main functions, and performance optimization, and step S7 further improves the design of the data interaction function between the FGC array and external devices, as well as the final external packaging design of the FGC chip.

### S7. Design of Other Modules, Chip I/O, and External Packaging:

In some embodiments, the data management module, the central scheduling module, a chip input/output (I/O), and the external packaging for the plurality of chip layers of each of the plurality of FGC modules are designed.

In some embodiments, the step S7 further includes the following sub-steps:

In S71, performing data management module design to achieve high-speed data transmission with the external device and to support any one or any combination of high-speed communication interface protocols, wherein the high-speed communication interface protocols include Peripheral Component Interconnect express (PCIe), Serializer/Deserializer (SerDes), Compute Express Link (CXL), or Universal Chip Interconnect express (UCIe).

In S72, performing central scheduling module design, wherein the central scheduling module is designed to send data to the plurality of FGC modules according to the data interaction protocol, receive results of data computation, and configure functions of the plurality of FGC modules prior to operation.

In S73, performing chip I/O design, comprising the following categories: high-speed data input/output pins, configuration/debugging and monitoring pins, clock and reset control pins, and power and ground pins. The count and the distribution arrangement of I/Os are configured according to the count of the plurality of FGC modules, the count of packaging layers, and the type of the communication protocol.

In S74, performing external package design, wherein the FGC array adopts a flip-chip packaging manner. The external chip package design prioritize high reliability, with a focus on optimizing heat dissipation paths to improve cooling efficiency and reduce system thermal resistance, including designing through-silicon vias (TSVs) dedicated to heat dissipation, and designing a thermal dissipation module including a heat sink or a vapor chamber, so as to enhance thermal conduction performance of the FGC array under a high-density stacking condition.

The functional modules for data interaction between the FGC array and the external device include: the data management module, the central scheduling module, etc. The data management module is responsible for high-speed data transmission with the external device, and the central scheduling module sends data to FGC modules according to the data interaction protocol from S3 and receives computation results. The data management module supports a plurality of high-speed communication interface protocols, including but not limited to PCIe, SerDes, UCIe, etc., to adapt to the application requirements, where the FGC chip as a main processor (i.e., using the FGC architecture), a co-processor, an embedded processor, or a heterogeneous integrated chiplet in different system architectures. The Chip I/O design includes but is not limited to the following categories: high-speed data input/output pins, configuration/debugging and monitoring pins, clock and reset control pins, power and ground pins, etc. The specific count and distribution arrangement of the I/O may be flexibly configured according to the count of the FGC modules, the count of packaging layers, and type of the communication protocol type. The FGC array inside the chip adopts flip-chip packaging, the external chip packaging design prioritizes high reliability, with a focus on optimizing the thermal paths, improve heat dissipation efficiency and reduce system thermal resistance, including but not limited to: designing TSVs dedicated to heat dissipation (Thermal TSVs), designing a thermal dissipation module including a heat sink or a vapor chamber, to enhance the thermal conductivity of the chip under high-density stacking conditions, ensuring long-term stable operation of the system.

The flip-chip packaging refers to an integrated circuit (IC) packaging technology where a side of the chip with transistors and interconnect lines faces downward, and an electrical connection to a packaging substrate or another chip is established directly through tiny bumps.

The core principle of the FGC architecture in the above design manner lies in abandoning the traditional central-bus-based control model. Unlike systems that rely on a central controller (e.g., a CPU) for global scheduling, the FGC architecture is based on modular design where each FGC module may independently complete computation, storage, and logic judgment internally. Each FGC module possesses complete processing capabilities, enabling it to autonomously handle data computation and storage management without requiring centralized scheduling by an external master controller. Within the system, data interaction relies entirely on the inter-module data interaction protocol, with the input and output of each module employing a unified interaction algorithm. This design allows computation and storage tasks to be completed autonomously within the modules, avoiding the complexity associated with centralized management dependent on an external bus and significantly reducing system management overhead. This decentralized design effectively overcomes the bottlenecks of the data bus, address bus, and control bus in the von Neumann architecture, demonstrating higher data processing efficiency and lower energy consumption in large-scale parallel computing.

Regarding the relationship between computation and memory, the FGC architecture adopts a tightly integrated design of memory fusion computing, which differs from the traditional model in the von Neumann architecture where computing and memory units are separate and independent. The FGC architecture achieves efficient collaboration between computing and memory units through specific data flow paths and an interaction protocol. Within each FGC module, both the memory units and the computing units employ a lightweight design. The memory units in each FGC module are laid out around the computing units according to algorithmic requirements (e.g., four to eight memory units distributed around each computing unit), forming a compact 3D distribution structure (e.g., some memory units are horizontally distributed around the computing units, while others are vertically integrated above and below the computing units). By arranging lightweight, low-heat-dissipation memory units around the computing units which generate significant concentrated heat, the issue of concentrated heat generation in 3D logic chips can be effectively mitigated, enhancing system reliability. This layout shortens the data transmission distance between memory and computing units, reducing latency and the energy consumption associated with parallel computing data access, further alleviating the thermal bottleneck of 3D logic chips. This layout design utilizing 3D stacking also enables further expansion of memory capacity, thereby improving data access efficiency, optimizing system performance and bandwidth utilization, and enhancing system reliability while reducing overall system energy consumption. More descriptions regarding the Memory Fusion Computing architecture may be found in FIG. 2 and related descriptions thereof.

The design of the FGC architecture has high system scalability and may flexibly adjust the count of FGC modules according to application requirements. By adding or reducing FGC modules, the architecture scale may be dynamically adjusted to meet computing performance or storage requirements. For example, when facing large-scale AI computing tasks, the processing capability may be quickly increased by expanding the count of FGC modules to ensure that the system meets performance requirements without changing the communication protocol or control logic between modules. This expansion capability ensures that the system can adapt to computing tasks of different scales and types, providing efficient and stable computing resources. Meanwhile, the distributed computing and storage manner of the FGC architecture gives it natural advantages in fault tolerance and reliability. Since the FGC modules are relatively independent from each other, a failure of a single module does not affect the normal operation of the entire system. Through redundant circuit design and intelligent scheduling, the FGC architecture can dynamically adjust the task load when a module failure occurs, ensuring the stability of the system.

The FGC architecture fully utilizes current advanced semiconductor processes, especially based on 3D IC and TSV technologies, to comprehensively optimize the integration of computing units and memory units. By adopting state-of-the-art packaging processes, the FGC architecture achieves higher integration density and smaller form factors on a single chip, while significantly enhancing performance and reducing power consumption. This architecture capitalizes on the advantages of existing processes, such as multi-layer stacking, high-density interconnects, and fine-grained power management, meeting stringent requirements for low power consumption, high reliability, and thermal management while ensuring high performance. Therefore, the FGC architecture not only adapts to the current process level but also provides flexible expansion space for future technological advancements, ensuring it maintains leading competitiveness in the rapidly evolving technological landscape.

Based on the aforementioned characteristics, the FGC architecture demonstrates high flexibility and compatibility, enabling seamless integration with future heterogeneous integration and Chiplet technologies. As integrated circuit design increasingly moves towards heterogeneous systems, traditional monolithic processor architectures can no longer meet diverse computational demands. Through its modular design, the FGC architecture can not only collaborate with different types of processing units (e.g., CPUs, GPUs, AI accelerators) but also enable independent integration of functional modules via Chiplet technology, thereby optimizing system performance and power consumption. Simultaneously, FGC modules can be embedded as hardware acceleration units into other processors to enhance their computing power, making them particularly suitable for tasks requiring large-scale parallel computing or high-speed data processing. By integrating FGC modules into heterogeneous processors, the system can dynamically configure computational resources based on specific application needs, fully leveraging the performance advantages of each module. This flexible integration approach not only provides efficient computing and storage capabilities but also significantly reduces integration costs and improves system scalability. Whether in artificial intelligence (AI), big data processing, or complex simulation scenarios, the FGC architecture remains compatible with other chip technologies, providing reliable hardware acceleration support and injecting more possibilities into the development of heterogeneous computing.

Embodiments of the present disclosure further provide an FGC system with neural network model generalization capability (abbreviated as the FGC system). The FGC system is constructed according to any of the embodiments of the three-dimensional artificial intelligence processor based on the Fine-Grained Cube architecture and its design method provided in the present disclosure. The FGC system customizes and configures a deep neural network structure with 2.44M parameters and completes testing on a Modified National Institute of Standards and Technology (MNIST) dataset.

In some embodiments, the FGC system is constructed within a five-layer stacked three-dimensional coordinate grid, where an X-axis ranges from 0-31 (32 columns in total), a Y-axis ranges from 0-31 (32 rows in total), and a Z-axis ranges from 0-4 (5 layers in total), with the Z-axis being a stacking direction. The specific functional module layout, address mapping, quantity, and functional description of the FGC system are shown in Table 1 below, totaling 32×32×5=5120 modules.

TABLE 1
FGC System Functional Schematic Table

| Module | 3D Coordinate | | |
|---|---|---|---|
| Type | Distribution Example | Quantity | Functional Description |
| FGC Module | All locations not | 5019 | Conventional processing module; |
| | occupied by other | | stores weights and performs |
| | functional modules | | multiply-accumulate |
| | configured for specific | | |
| | functions, e.g., (0, 0, 0) | | |
| L1o Module | Distributed across three | 48 | Stores activation values; executes |
| | layers (z = 0, 2, 4); | | non-linear functions (e.g., ReLU); |
| | located around L2 | | supports bias updates. |
| | modules in each layer; | | |
| | 3D coordinates (L1_x, | | |
| | L1_y, L1_z), e.g., | | |
| | (3, 3, 2) | | |
| L1a Module | (L1_x + 1, L1_y, L1_z) | 48 | Performs data forwarding, address |
| | | | mapping, and routing. |
| L2 Module | (7, 7, 2), (7, 23, 2), | 4 | Schedules regional tasks and |
| | (23, 7, 2), (23, 23, 2) | | reconstructs data storage mapping. |
| L3 Module | (16, 16, 4) | 1 | Outputs results, computes errors, |
| | | | and broadcasts backpropagation |
| | | | signals. |
| Bottom- | (0, 0, 5) | 1 (not | External I/O, configuration, and |
| Layer | | counted | initialization. |
| Module | | in total) | |
| (Data | | | |
| Interaction | | | |
| Chip) | | | |

In Table 1, the L1 modules are primary group leader modules among the FGC management modules, the L2 modules are secondary group leader modules, and the L3 module is a tertiary group leader module. The L1, L2, and L3 modules are all FGC management modules, with their authority progressively increasing and their quantity progressively decreasing from L1 to L3. The bottom-layer module is a module responsible for handling input/output functions between the FGC system and external devices, such as a data interaction chip. Since the storage capacity of each module is limited, and it is necessary to ensure that the chip layout dimensions of the FGC modules and the functional modules configured for specific functions are essentially the same, the FGC system in this embodiment splits the L1 module into an L1o module and an L1a module.

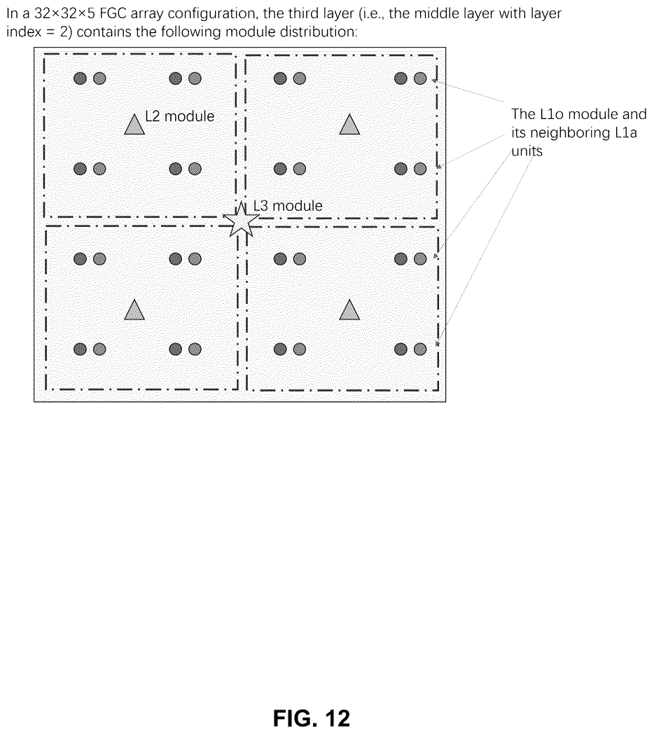

FIG. 12 is a top view showing a distribution of FGC system modules according to some embodiments of the present disclosure. In some embodiments, the distribution of FGC system modules is as shown in FIG. 12, where the L3 module is located at a center of the FGC system, receiving information from four surrounding L2 modules. Each L2 module is responsible for an 8×8×5 block of modules, is located at the center of its respective region, and manages the scheduling of weight data and activation value data within that region. L1o modules and L1a modules appear in pairs and are distributed around the L2 modules.

To verify that the FGC system can handle complex neural networks and possesses parallel computing capabilities, a deep fully connected neural network is adopted for testing. The neural network model involves a total of 2,442,496 weight parameters. The specific network structure is shown in Table 2 below:

TABLE 2
Schematic of the Fully Connected Neural Network Model

| | | Count of | |
|---|---|---|---|
| Layer | Type | Neurons | Input Dimension |
| L0 | Input Layer | 784 | 28 × 28 image pixels |
| L1 | Hidden Layer 1 | 1024 | 784 |
| L2 | Hidden Layer 2 | 1024 | 1024 |
| L3 | Hidden Layer 3 | 512 | 1024 |
| L4 | Hidden Layer 4 | 128 | 512 |
| L5 | Output Layer | 10 | 128 |

In the FGC system, all data is exchanged in the form of packets. Each packet contains sixteen 32-bit data units. Data attributes are divided into 32-bit types and 20-bit types. Packet types include input data packets, output data packets, weight transmission packets, backpropagation packets, weight storage packets, activation value packets, activation and bias storage packets, address configuration packets, etc. The input data packets are used for transmitting data to FGC modules. The output data packets are used for transmitting data from FGC modules to L1o modules. The weight transmission packets are used by the bottom-layer module to initialize weight data in FGC modules. The backpropagation packets are used throughout the entire process during backpropagation, including the bias update and weight update processes. The weight storage packets are used by L2 modules to package weight data to be sent to FGC modules when scheduling weight mapping. The activation value packets are used by L2 modules to package data to be sent to L1o modules when scheduling activation values and biases. The activation and bias storage packets are used by the bottom-layer module to initialize activation values and biases in L1o modules. The address configuration packets are used by the bottom-layer module to initialize the address mapping table in L1a modules.

The operation of the FGC system comprises three stages: a system initialization stage, a data forward propagation stage, and a reverse data update stage. The main tasks of the system initialization stage are: defining a structure of the network model within the FGC system; initializing weight storage data in the FGC modules; initializing activation values and bias data in the L1o modules; and initializing address mapping table(s) in the L1a modules. The address mapping table may be custom-defined and loaded into the FGC system via the bottom-layer module, or it may be randomly assigned, because during subsequent computation, the L2 module may optimize the calculation process and adjust the address mapping table.

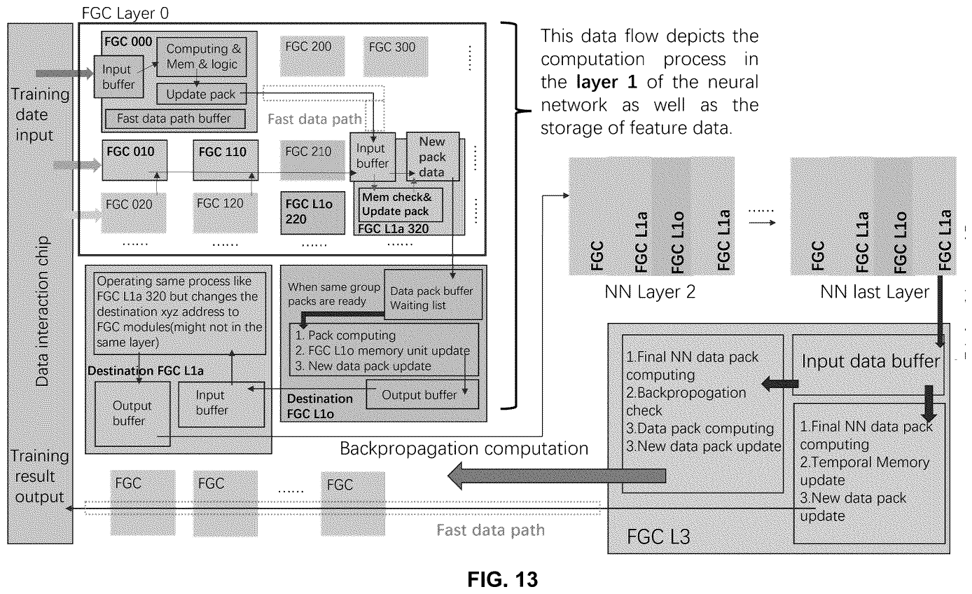

FIG. 13 is a schematic diagram of a data flow for forward propagation in an FGC system according to some embodiments of the present disclosure.

In some embodiments, the data flow during the forward propagation stage is as shown in FIG. 13, which primarily illustrates the data transmission path within Layer 1 using examples such as FGC 000. The transmission paths in the remaining layers are substantially the same. After input data enters each FGC module, parallel matrix multiplication calculations are performed. The results are then packaged into the format of output data packets and sent to the nearest L1a module for addressing. The L1a module modifies the address attribute within the data packet and forwards the data packet to the target L1o module. Since the system processes data in groups of 16, the target L1o module must wait for all 16 data units to arrive. Upon arrival, the target L1o module completes an activation function non-linearization process, updates the stored activation function value, and, via a neighboring L1a module, addresses and sends the data to the FGC module of a next network layer. This process repeats iteratively to complete forward data computation and activation value updates. When the data is transmitted to an L3 module (the final address in the address mapping table during forward propagation is the address of the L3 module), the L3 module compares the calculation results. If the FGC system is in a training mode, the FGC system proceeds to the error backpropagation stage; if the FGC system is in an inference mode, it directly outputs the calculation result.

The backpropagation stage primarily performs update calculations for weights and biases. The process of backpropagation for a fully connected neural network is governed by a series of equations, denoted as BP1 through BP4, which describe the computation of gradients and the update of parameters within each network layer. In these equations, the symbol “.” denotes standard matrix multiplication, while the symbol “*” denotes the Hadamard product (element-wise multiplication):

$${δ}^{L} = {∇}_{a} C * {σ}^{′} ( {z}^{L} ) , \qquad ( BP 1 )$$

$${δ}^{l} = ( {( {ω}^{l + 1} )}^{T} \cdot {δ}^{l + 1} ) * {σ}^{′} ( {z}^{l} ) , \qquad ( BP2 )$$

$$\frac{\partial C}{\partial {b}_{j}^{l}} = {δ}_{j}^{l} , \qquad ( BP3 )$$

$$\frac{\partial C}{\partial {ω}_{jk}^{l}} = {a}_{k}^{l - 1} \cdot {δ}_{j}^{l} . \qquad ( BP4 )$$

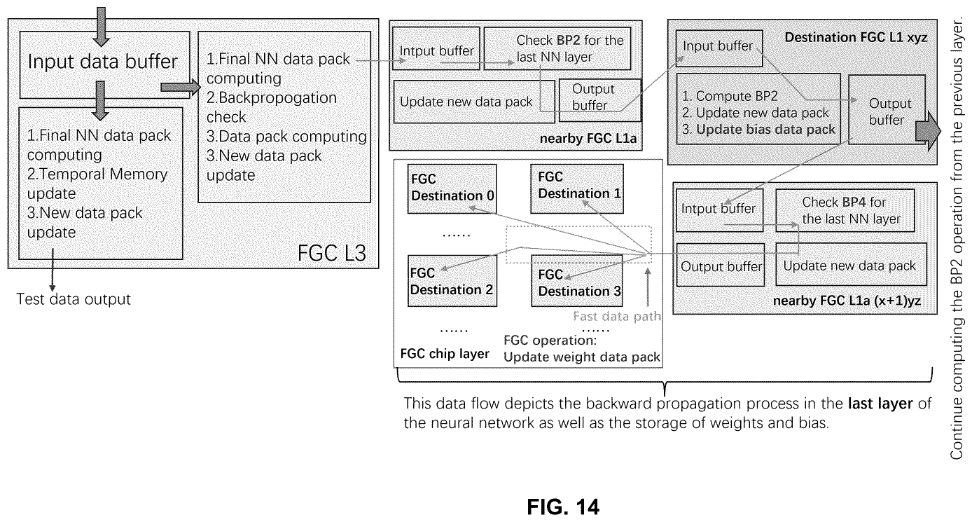

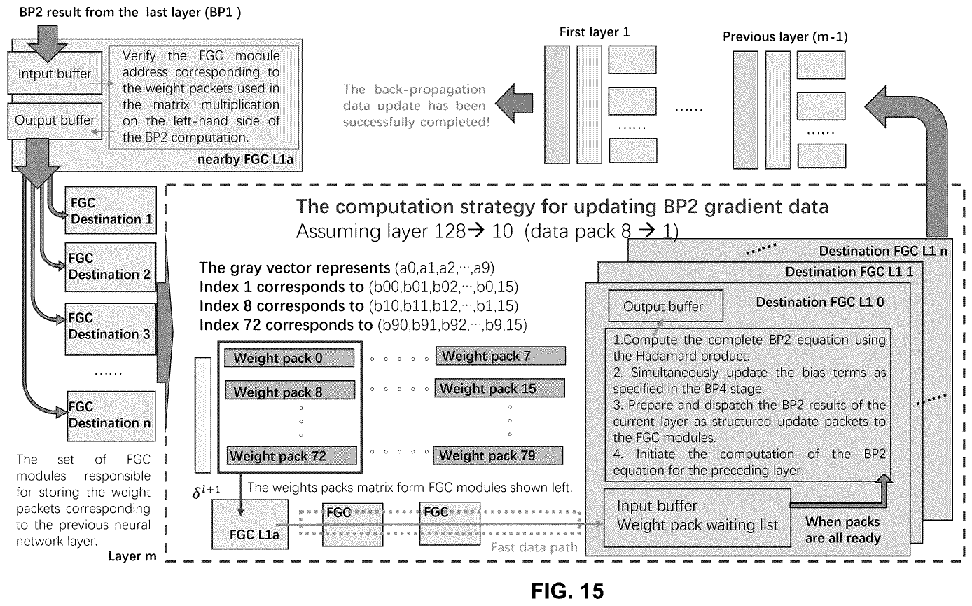

FIG. 14 is a schematic diagram of a data flow for backpropagation in a final neural network layer of an FGC system according to some embodiments of the present disclosure. FIG. 15 is a schematic diagram of a data flow for backpropagation in other neural network layers of an FGC system according to some embodiments of the present disclosure.

In some embodiments, the data flow during the backpropagation stage is as shown in FIGS. 14 and 15. First, the L3 module compares a final inference result with a true label vector using a predefined loss function (e.g., cross-entropy or mean squared error, MSE). The resulting loss output (i.e., the computed value from the loss function) is converted into backpropagation packets containing quantized error gradients and their corresponding feature indices. The backpropagation packets are then broadcast to the corresponding L1a modules according to a reverse routing table and forwarded to target L1o modules. The target L1o modules perform a BP2 calculation process, which involves multiplying the received backpropagation packets by the derivative of the local activation function (e.g., ReLU). The BP2 gradients are then encapsulated into packets, appended with layer and coordinate information, and distributed to the FGC modules responsible for the weights of the preceding layer. The BP2 calculation process may be represented by the following Equation (1):

$${δ}_{Bp 2} = {δ}_{L 3} \cdot {f}^{′} ( x ) , \qquad ( 1 )$$

wherein δ_{Bp2} denotes the BP2 gradient (the error gradient computed by the L1o module in BP2 for the preceding layer), δ_{L3} represents the backpropagation packet received by the target L1o module (i.e., the loss output from L3), and ƒ′(x) represents the derivative of the local activation function.

Upon receiving the BP2 packets, the FGC modules utilize the BP2 packets to perform local weight updates, employing stochastic gradient descent or a simplified fixed-point optimizer. Each module applies an update rule represented by the following Equation (2):

$${ω}_{i j} = {ω}_{i j} - η \cdot {δ}_{j} \cdot {x}_{i} , \qquad ( 2 )$$

wherein ωᵢⱼ denotes a weight, η denotes a learning rate, δⱼ denotes a BP2 error term, and xᵢ denotes a stored forward activation value. Since the weights are stored in SRAM units or register units of each FGC module, the update operation may be completed locally without requiring external memory access. Simultaneously, the L1o modules update their local bias terms using accumulated δ values. Some training strategies may also involve the propagation of secondary δ values, where the L1o modules send feedback to preceding L1a or L2 modules for cross-layer consistency or planned retraining. The principle for reverse data updates in the remaining layers is the same.

The entire backpropagation computation process is executed in a data-driven manner. Implicit synchronization barriers are set at the L3 and L2 layers to aggregate completion flags and convergence metrics (e.g., a total loss, a weight drift). The convergence metrics may be further forwarded to the bottom-layer chip to enable adaptive learning rate adjustment or early termination of training.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This manner of disclosure, however, is not to be interpreted as reflecting an intention that the claimed subject matter requires more features than are expressly recited in each claim. Rather, inventive embodiments lie in less than all features of a single foregoing disclosed embodiment.

The numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. The numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A three-dimensional (3D) artificial intelligence (AI) processor based on a Fine-Grained Cube (FGC) architecture, comprising: an FGC array, a central scheduling module, a data management module, and a 3D power supply circuit; wherein
the FGC array includes a plurality of FGC modules arranged in an expandable three-dimensional layout; each of the plurality of FGC modules includes one or more computing units, one or more memory units, and one or more logic units that are integrated through a Memory Fusion Computing architecture; the one or more computing units are configured to perform data operations, the one or more memory units are configured to store data, and the one or more logic units are configured to determine a type of operation to be performed on data; each of the FGC modules further comprises one or more cache modules configured to cache data;
data transmission between the plurality of FGC modules and between the plurality of FGC modules and the central scheduling module is performed via a data interaction protocol;
the central scheduling module is configured to perform corresponding functional configuration of the FGC modules based on the data interaction protocol, configure data attributes, authorize a selected count of FGC modules according to a hierarchical management mechanism, and monitor a portion of the authorized FGC modules;
the data management module is configured for data communication with an external device; and
the 3D power supply circuit is configured for system power supply.

2. The three-dimensional artificial intelligence processor based on the FGC architecture of claim 1, wherein
the Memory Fusion Computing architecture distributes the one or more computing units, the one or more memory units, and the one or more logic units on a 3D multi-layer stacked chip or a two-dimensional (2D) single-layer chip according to functional and usage requirements.

3. The three-dimensional artificial intelligence processor based on the FGC architecture of claim 2, wherein
the data interaction protocol dynamically determines and schedules data flow paths by adding data attributes to input data to the plurality of FGC modules or modifying data attributes of output data from the plurality of FGC modules; and
data is transmitted between the plurality of FGC modules by establishing connection paths.

4. The three-dimensional artificial intelligence processor based on the FGC architecture of claim 3, wherein
the data attributes include one of a data type attribute, a layer attribute, or an operation attribute, or any combination thereof;
the data type attribute includes the input data, the output data, network weights, biases, or feature map data;
the layer attribute indicates a layer of a neural network in which the data is located; and
the operation attribute indicates an operation performed on the data within the plurality of FGC modules, the operation includes multiplication, addition, or non-linearization.

5. The three-dimensional artificial intelligence processor based on the FGC architecture of claim 3, wherein
the hierarchical management mechanism includes performing hierarchical management on the FGC modules and authorizing a selected count of FGC modules with a corresponding distribution via the central scheduling module, and the authorized FGC modules are configured to monitor and regulate operations of unauthorized FGC modules in adjacent regions of the authorized FGC modules to prevent excessive divergence of data flow, wherein the authorization includes granting a plurality of different levels of management authority, and management modes include step-by-step management and cross-level direct management.

6. The three-dimensional artificial intelligence processor based on the FGC architecture of claim 1, wherein
a 3D packaging technology is adopted to vertically stack and system-integrate a plurality of chip layers, each of the plurality of chip layers is a single silicon die containing functional units of the plurality of FGC modules, and the plurality of chip layers collectively form the FGC array that comprises the plurality of FGC modules; and
the 3D packaging technology includes using a copper-copper bonding technology, a hybrid bonding technology, a solder technology, or a Through-Silicon Via (TSV) technology to achieve high-density vertical interconnects.

7. The three-dimensional artificial intelligence processor based on the FGC architecture of claim 1, wherein
a stacking arrangement of the FGC array includes one of a ring topology structure, a tree topology structure, or a honeycomb topology structure, or any combination thereof.

8. A method for designing a three-dimensional (3D) artificial intelligence (AI) processor based on a Fine-Grained Cube (FGC) architecture, the method being applied to the 3D AI processor based on the FGC architecture according to claim 1, and the method comprising:
S1. FGC architecture design:
wherein the FGC architecture design comprises an FGC array design, including designing a topology structure for a 3D stacked distribution of the plurality of FGC modules according to different application requirements and applicable scenarios;
S2. FGC module design:
wherein each of the plurality of FGC modules has a 3D stacked structure, and the FGC module design comprises designing the 3D stacked structure of the one or more computing units, the one or more memory units, and the one or more logic units of each of the plurality of FGC modules, such that the one or more computing units, the one or more memory units, and the one or more logic units are closely laid out based on the Memory Fusion Computing architecture, and a distribution of each functional unit is selected as a single-layer distribution or a distribution across multiple chip layers based on application requirements;
S3. Data interaction protocol design:
wherein the data interaction protocol designed comprises:
adding data attributes to input data to the plurality of FGC modules and modifying data attributes of output data from the plurality of FGC modules, to achieve scheduling control of data flow paths, wherein the plurality of FGC modules execute corresponding operations on the data based on the data attributes; and
performing authorized management of the plurality of FGC modules according to a hierarchical management mechanism, wherein the central scheduling module grants group leader authority to a selected count of FGC modules, and the FGC modules granted the group leader authority monitor data flow states of FGC modules in adjacent regions to prevent excessive divergence of data flow;
S4. Three-dimensional (3D) stacked chip packaging design:
wherein the 3D stacked chip packaging design comprises packaging a plurality of chip layers using a 3D packaging technology, wherein high-density through-silicon vias (TSVs) are used as inter-layer interconnect structures for physical connections;
S5. Low-power and reliability design:
wherein the low-power and reliability design comprises:
designing the 3D power supply circuit, and performing low-power optimization by powering down idle FGC modules or powering on standby FGC modules in the FGC array; and
designing redundant circuits in the plurality of FGC modules, such that when a portion of the plurality of FGC modules or a functional unit within a FGC module fail, an automatic switch is made to other FGC modules or other functional units to complete substitute tasks;
S6. Optimization combining a front-end logic design and a back-end packaging structure design:
wherein the front-end logic design includes adopting a circuit layout from step S2 and a data flow path algorithm from step S3 that are adapted to three-dimensional stacking requirements, such that the FGC array is designed with the plurality of chip layers, and circuit design takes into account communication latency between the plurality of chip layers; and
the back-end packaging structure design includes optimizing a physical structure of a 3D circuit based on a count of interconnects in the plurality of FGC modules from the front-end design, so as to ensure that requirements for high-density TSV manufacturing are met;
S7. Other modules and packaging interface design, comprising:
designing the data management module, the central scheduling module, a chip input/output (I/O), and an external package for the plurality of chip layers of each of the plurality of FGC modules.

9. The method of claim 8, wherein step S7 comprises the following sub-steps:
S71, performing data management module design to achieve high-speed data transmission with the external device and to supporting any one or any combination of high-speed communication interface protocols, wherein the high-speed communication interface protocols include Peripheral Component Interconnect express (PCIe), Compute Express Link (CXL), or Universal Chip Interconnect express (UCIe);
S72, performing central scheduling module design, wherein the central scheduling module is designed to send data to the plurality of FGC modules according to the data interaction protocol, receive results of data computation, and configure functions of the plurality of FGC modules prior to operation;
S73, performing chip I/O design, comprising the following categories:
high-speed data input/output pins, configuration/debugging and monitoring pins, clock and reset control pins, and power and ground pins; wherein a count and a distribution arrangement of I/Os are configured according to a count of the plurality of FGC modules, a count of packaging layers, and a type of a communication protocol;
S74, performing external package design, wherein the FGC array adopts a flip-chip packaging manner; the external chip package design prioritize high reliability, with a focus on optimizing heat dissipation paths to improve cooling efficiency and reduce system thermal resistance, including designing TSVs dedicated to heat dissipation, and designing thermal dissipation modules including a heat sink or a vapor chamber, so as to enhance thermal conduction performance of the FGC array under a high-density stacking condition.

10. An application of the three-dimensional (3D) artificial intelligence (AI) processor based on a Fine-Grained Cube (FGC) architecture according to claim 1, wherein:
the 3D AI processor based on the FGC architecture is applied as a main processor, a co-processor, an embedded processor, a heterogeneously integrated chiplet, or as a standalone Intellectual Property (IP) core embedded into a target platform.
